(19) United States
(12) Patent Application Publication
(10) Pub. No.: US 2009/0251258 A1
(43) Pub. Date: Oct. 8, 2009

(54) MAGNETIC HELICAL SCREW DRIVE

(75) Inventors: Kenneth Rhinefrank, Corvallis, OR (US); Alexandre F.T. Yokochi, Corvallis, OR (US); Annette von Jouanne, Corvallis, OR (US); Manfred Dittrich, Corvallis, OR (US); Emmanuel Agamloh, Holly Springs, NC (US)

Correspondence Address: KLARQUIST SPARKMAN, LLP, 121 SW SALMON STREET, SUITE 1600, PORTLAND, OR, 97204, US

(73) Assignees: The State of Oregon acting by and through the State Board of Higher Education on behalf of; Oregon State University, Corvallis, OR (US)

(21) Appl. No.: 12/420,720

(22) Filed: Apr. 8, 2009

Related U.S. Application Data
(60) Provisional application No. 61/123,645, filed on Apr. 8, 2008.

(51) Int. Cl. H01F 7/02; F03B 13/12

(52) U.S. Cl. 335/306; 290/53

(57) ABSTRACT

A system can comprise a screw and a nut, which are configured to move relative to each other. Each of the screw and the nut components can comprise one or more magnets configured to exert a repulsive force on one or more magnets of the other component as a result of the relative motion. Interactions between the one or more magnets of the screw and the one or more magnets of the nut can allow for conversion between linear motion and rotary motion. One or more tools can be used to aid in manufacturing the screw and/or the nut. In some embodiments additional components can aid in maintaining alignment of the screw and the nut.

### CROSS REFERENCE TO RELATED APPLICATION

This application claims the benefit of U.S. Provisional Patent Application No. 61/123,645, titled MAGNETIC HELICAL SCREW DRIVE, filed Apr. 8, 2008, which is incorporated herein by reference.

### FIELD

This disclosure generally relates to apparatus and methods for converting between linear and rotary motion.

### BACKGROUND

Techniques and devices for converting between linear and rotary motion have many applications. However, physical contact between components of linear-to-rotary devices can cause one or more components to wear over time, possibly reducing the performance of such devices.

### SUMMARY

A system can comprise a screw component and a nut component, which can be configured to move relative to each other. Each of the screw component and the nut component can comprise one or more magnets configured to exert a repulsive force on one or more magnets of the other component as a result of the relative motion. Interactions between the one or more magnets of the screw and the one or more magnets of the nut can allow for conversion between linear motion and rotary motion. One or more tools can be used to aid in manufacturing the screw and/or the nut. In some embodiments, additional components can aid in maintaining alignment of the screw and the nut.

In some embodiments, an apparatus comprises: a first magnet support; a first plurality of magnets coupled to the first magnet support in a first helix arrangement; a second magnet support having a cavity extending through at least a portion of the second magnet support, the cavity being configured to receive at least a portion of the first magnet support with one or more of the first plurality of magnets; and a second plurality of magnets coupled to the second magnet support in a second helix arrangement at least partially about the cavity, and wherein the first plurality of magnets is configured to exert a repulsive force on the second plurality of magnets when the at least a portion of the first magnet support with one or more of the first plurality of magnets coupled thereto moves in the cavity relative to the second magnet support. The first magnet support can comprise a first longitudinal axis and wherein the first plurality of magnets is magnetized radially outward relative to the first longitudinal axis, wherein the second magnet support comprises a second longitudinal axis, and wherein the second plurality of magnets is magnetized radially inward relative to the second longitudinal axis. The first magnet support can comprise one or more helical cavities configured to receive one or more of the first plurality of magnets. The second magnet support can comprise one or more helical cavities configured to receive one or more of the second plurality of magnets. In some cases, at least some of the first plurality of magnets have an angular width of about 30 degrees. The apparatus can have a void between a first magnet and a second magnet in the first plurality of magnets, wherein the void is at least partially filled with one or more non-magnetic materials. The first plurality of magnets can form a generally smooth first helical face and a generally discontinuous second helical face, wherein the first helical face opposes the second helical face. The apparatus can further comprise one or more alignment components coupled to the first magnet support, the one or more alignment components coupled to the first magnet support can comprise at least one guide block coupled to the first magnet support so as to be moveable relative to the first magnet support. The one or more alignment components can further comprise means for positioning the at least one guide block as a result of motion of the second magnet support. The one or more alignment components can further comprise a realignment component configured to position the at least one guide block as a result of motion of the second magnet support. The one or more alignment components can further comprise one or more rods coupled to the at least one guide block, a first radial bearing configured to exert a first centering force on a first end of the first magnet support, and a second radial bearing configured to exert a second centering force on a second end of the first magnet support.

The apparatus can be used in a linear actuator or an ocean wave energy converter system. The apparatus can be used in a method of converting between linear motion and rotary motion, wherein the method comprises engendering relative motion between the first magnet support and the second magnet support when the at least a portion of the first magnet support with one or more of the first plurality of magnets coupled thereto is in the cavity of the second magnet support.

An embodiment of a method can comprise: placing a portion of a magnet support adjacent to a magnet assembly tool, the tool comprising a magnet retainer of one or more magnetic materials; placing a magnet segment adjacent to the magnet support and the magnet retainer, such that the magnet segment is magnetically coupled to the magnet retainer; attaching the magnet segment to the magnet support; and incrementally advancing the magnet support relative to the magnet assembly tool so as to distance the magnet segment further from the magnet retainer. The magnet support can comprise one or more helical cavities for receiving the magnet segment. The method can further comprise encasing the magnet segment and at least a portion of the magnet support. In some embodiments, the magnet is a first magnet, and the method further comprises, before incrementally advancing the magnet support relative to the magnet assembly, placing a second magnet segment adjacent to the magnet support and the magnet retainer, and attaching the second magnet segment to the magnet support. A void between the first magnet segment and the second magnet segment can be filled with one or more non-magnetic materials. An apparatus can be made according to this method.

In additional embodiments, an apparatus comprises: a magnet support comprising a longitudinal axis and a surface; and a plurality of magnet segments coupled to the surface, wherein the plurality of magnets form at least a portion of a helix relative to the longitudinal axis, and wherein substantially all of the magnets coupled to the surface are magnetized in a common direction. One or more helical cavities can be adjacent to the surface of the magnet support, wherein the plurality of magnet segments are coupled to the one or more helical cavities. In some cases, the magnet support is a first magnet support, the longitudinal axis is a first longitudinal axis, the plurality of magnet segments is a first plurality of magnet segments, the common direction is a first common direction, and the surface is a first surface, the apparatus further comprising: a second magnet support comprising a second longitudinal axis, a second surface and a cavity configured to receive at least a portion of the first plurality of magnet segments; and a second plurality of magnet segments coupled to the second surface, wherein the second plurality of magnets form at least a portion of a second helix relative to the second central axis, wherein substantially all magnets on the second surface are magnetized in a second common direction, and wherein the second common direction is generally opposite to the first common direction.

An apparatus for assembling magnets on a magnet support can comprise: a body, the body comprising a body opening configured to receive the magnet support; a restraint positioned adjacent to the body opening, the restraint comprising an inner surface, an outer surface, and a restraint opening configured to receive one or more magnets for coupling with the magnet support; and a magnet retainer coupled to the inner surface of the restraint, wherein the magnet retainer comprises one or more magnetic materials. In some cases, the body opening has a first diameter and the inner surface of the restraint has a second diameter. The magnet retainer can comprise a wedge-shaped body and can be offset from the restraint opening.

### BRIEF DESCRIPTION OF THE DRAWINGS

FIG. 1A shows a side view of an exemplary embodiment of an ocean wave energy converter system.

FIG. 1B shows a plan view of the ocean wave energy converter system of FIG. 1A.

FIG. 2A shows a side cross-section view of an exemplary embodiment of an ocean wave energy converter system.

FIG. 2B depicts a side cross-section view of an exemplary embodiment of a magnet piston assembly.

FIG. 2C depicts a side cross-section view of an alternate embodiment of the system of FIG. 2A.

FIG. 3 depicts side cross-section views of exemplary magnet configurations for a magnet piston assembly.

FIG. 4 depicts a plot of exemplary finite element analysis results for some configurations of FIG. 3.

FIG. 5 depicts a plot of exemplary generator test results of generator rotation speed as a function of thrust.

FIG. 6 depicts a plot of exemplary generator test results of generator current as a function of thrust.

FIG. 7 depicts a plot of exemplary generator test results of generator efficiency as a function of generator power output.

FIG. 8 depicts an exemplary equivalent circuit of a permanent magnet synchronous generator.

FIG. 9 shows a graph of simulated voltage generation for the system of FIG. 2A.

FIG. 10 shows a sample oscilloscope waveforms showing a no-load voltage generation for the system of FIG. 2A.

FIG. 11A-11C show sample oscilloscope waveforms from test results of the system of FIG. 2A for output voltage, output current, and output power, respectively.

FIG. 12A-12C show sample oscilloscope waveforms from irregular wave test results of the system of FIG. 2A for output voltage, output current, and output power, respectively.

FIG. 13A shows a cross-section side view of an exemplary embodiment of an ocean wave energy converter system.

FIG. 13B shows a close-up cross section side view of an exemplary embodiment a magnet assembly and center screw.

FIG. 13C shows a close-up cross section side view of an exemplary embodiment of a magnet assembly.

FIG. 13D shows a top cross-section view of an exemplary embodiment of FIG. 13A.

FIGS. 14A-C show views of an exemplary embodiment of an ocean wave energy converter system featuring multiple spars.

FIG. 15 shows exemplary embodiments of screw and nut components for converting between linear and rotary motion.

FIG. 16 shows a cross-section view of one embodiment of a portion of a nut and a screw.

FIGS. 17A-D show views of one exemplary embodiment of a magnet.

FIGS. 18A-D show views of one exemplary embodiment of a magnet.

FIGS. 19A-D show views of one exemplary embodiment of a magnet.

FIGS. 20A-E show views of one exemplary embodiment of a magnet.

FIGS. 21A-E show views of one exemplary embodiment of a magnet.

FIG. 22 shows a horizontal cross-section view of the apparatus of FIG. 15.

FIGS. 23 and 24 show exemplary directions of magnetization for magnets.

FIG. 25 shows a block diagram of an exemplary method for assembling at least a portion of a screw.

FIG. 26 shows a block diagram of an exemplary method for assembling at least a portion of a nut.

FIGS. 27A-B show views of an exemplary embodiment of a screw scaffold.

FIGS. 28A-C show views of an exemplary embodiment of a nut scaffold.

FIG. 29 shows a perspective view of a portion of a screw scaffold with some magnets.

FIG. 30 shows a perspective view of a portion of a nut scaffold with some attached magnets.

FIG. 31 shows portions of a perspective view of a portion of a screw scaffold inside a portion of a nut scaffold.

FIG. 32 shows a front view of an exemplary embodiment of a tool for assembling magnets onto a scaffold.

FIG. 33 shows a plan view of an exemplary embodiment of a tool for assembling magnets onto a scaffold.

FIG. 34 shows a bottom view of an exemplary embodiment of a tool for assembling magnets onto a scaffold.

FIG. 35 shows a perspective view of a portion of an exemplary embodiment of a tool for assembling magnets onto a scaffold.

FIG. 36 shows a block diagram of an exemplary method for using a tool to assemble magnets onto a scaffold.

FIG. 37 shows an exemplary embodiment of a system for maintaining alignment between screw and nut components.

FIG. 38 shows a plan view of an exemplary embodiment of a guide block.

FIG. 39 shows an exemplary embodiment of a system for maintaining alignment between screw and nut components.

FIGS. 40, 41, 42 and 43 show details of an exemplary embodiment of the system of FIG. 39.

FIG. 44 shows a plan view of an exemplary embodiment of a radial bearing.

FIG. 45 shows a side view of an exemplary embodiment of a radial bearing.

FIG. 46 shows a graph of exemplary net torque calculations for a magnetic helical screw drive.

FIG. 47 shows a graph of exemplary total repulsive force calculations for a nut.

FIG. 48 shows a graph of exemplary repulsive force calculations.

### DETAILED DESCRIPTION

Disclosed herein are embodiments of technologies and/or related systems and methods for converting between linear motion and rotary motion. The embodiments should not be construed as limiting in any way. Instead, the present disclosure is directed toward all novel and nonobvious features and aspects of the various disclosed methods, apparatus, and equivalents thereof, alone and in various combinations and subcombinations with one another. The disclosed technologies are not limited to any specific aspect or feature, or combination thereof, nor do the disclosed methods and apparatus require that any one or more specific advantages be present or problems be solved. Although at least some exemplary embodiments disclosed herein are described in the context of an ocean wave energy converter (OWEC) system, the disclosed technologies are not limited to OWEC systems. At least some embodiments of the technologies are generally applicable for conversion between linear motion and rotary motion, regardless of the setting. For example, at least some of the disclosed technologies can be used in linear actuator systems (e.g., in hostile environments, in rudder controls, in elevator controls) or in oil drilling applications. At least some of the methods described herein can be automated using one or more manufacturing and/or assembly systems, although for simplicity such systems are not necessarily described in detail.

As used in this application and in the claims, the singular forms “a,” “an” and “the” include the plural forms unless the context clearly dictates otherwise. Additionally, the term “includes” means “comprises.” The phrase “and/or” can mean “one or more of” the elements described in the sentence. Further, the term “coupled” means electrically, electromagnetically or mechanically coupled or linked and does not exclude the presence of intermediate elements between the coupled items. Embodiments described herein are exemplary embodiments of the disclosed technologies unless clearly stated otherwise.

Although the operations of some of the disclosed methods and apparatus are described in a particular, sequential order for convenient presentation, it should be understood that this manner of description encompasses rearrangement, unless a particular ordering is required by specific language set forth below. For example, operations described sequentially can in some cases be rearranged or performed concurrently. Moreover, for the sake of simplicity, the attached figures may not show the various ways in which the disclosed methods and apparatus can be used in conjunction with other methods and apparatus.

### Exemplary Buoy Generator System Overview

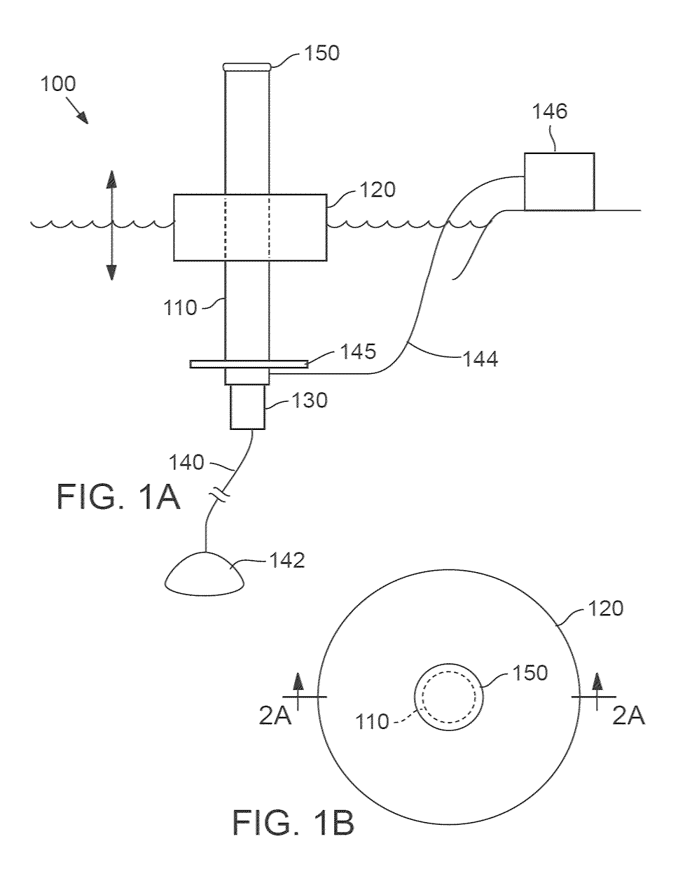

FIG. 1A shows a side view of one embodiment of a buoy generator system (e.g., an OWEC system) 100. The buoy generator system 100 comprises an elongated spar 110 and a float 120. The spar 110 can have a cross section that is round, square, or a number of other shapes, is desirably at least partially hollow, and is preferably constructed of a material that can withstand ocean conditions for a relatively long period of time, such as PVC, fiberglass, or composite material. In some embodiments the spar is a post or a pier of a dock. The float 120 is coupled to the spar 110 for movement relative to the spar. Desirably the float 120 encircles the spar 110 at least in part, but preferably entirely, and can be comprised of any number of buoyant materials as are well known in the art. The system 100 can further comprise a ballast weight 130 and a tether 140. FIG. 1A shows the tether 140 as being connected to the ballast weight 130, but it can also be connected to other parts of the system 100, e.g., to the spar 110. The remote end of the tether 140 is connected to a mooring system 142, which can be any system or arrangement that allows the system 100 to maintain a relatively constant geographic position. For example, the mooring system could comprise a weight such as an anchor or pilings. An electric cable 144 carries electricity from the system 100 to another location, e.g., a shore-based electric facility 146. The top end of the spar 110 can be sealed by, for example, a cap 150 to protect its contents from the elements. The spar 110 is preferably configured such that it (with its contents) is approximately neutrally buoyant. The system 100 can also comprise a wave deflector or wave motion resistor, such as a wave plate 145, which can be attached or coupled to the spar 110, usually at a right angle to the spar 110. However, the wave plate 145 can also be attached at other angles. The wave plate 145 can provide a dampening force to improve a desirable relative linear motion of the float 120 and the spar 110. FIG. 1B shows a top view of the system 100.

Generally, the generator system 100 can be moored offshore in an area where waves are common. As waves propagate past the system 100, the waves move the float 120 generally upwardly and downwardly relative to and along the spar 110. The system 100 converts at least some of the relative motion provided by the waves to rotary motion, which is used to turn an electric generator. As will be shown in example embodiments below, the system 100 can accomplish this conversion with the float 120 and with a power take-off (PTO) system (not shown) inside the spar 110. Preferably, there is a magnetic coupling such that, for example, there is little or no mechanical coupling between the float 120 and the PTO system inside the spar 110 that requires a breach of the wall of the spar 110. However, in further embodiments mechanical coupling between these components can be used.

It should be noted that although the motion of the float 120 to the spar 110 can be described and is often described in the application as “relative linear motion,” other types of motion can also be used. For example, if the spar 110 is curved, the float 120 can slide along the spar 110 in an arcuate motion. In some embodiments, the float 120 can spin relative to the spar 110, but these spins can be dampened by the inertia of the float 120, which can be designed to be larger than that of the spar 110.

One potential advantage of relying on a magnetic connection (rather than a mechanical connection) is increased durability in severe conditions (e.g., rough seas) of the systems described above. For example, the float 120 can be configured to “slip” when a force exceeding a selected threshold is applied to it. When the rough see conditions subside, it can slide back into place on the spar 110 and resume normal operation. The cap 150 and the plate 145 prevent total separation of the float 120 and the spar 110 in this example.

### System Using a Contact-Less Force Transmission System

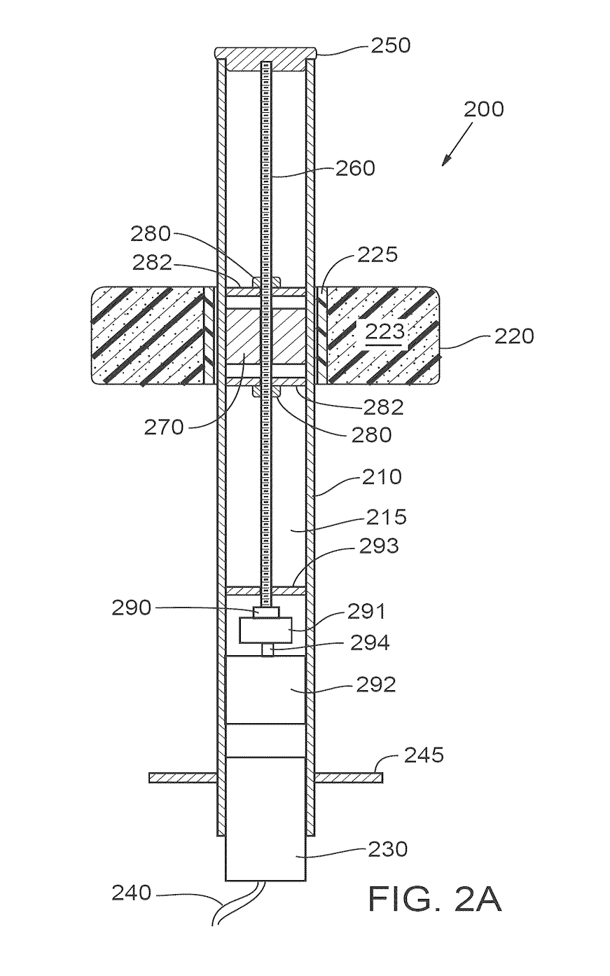

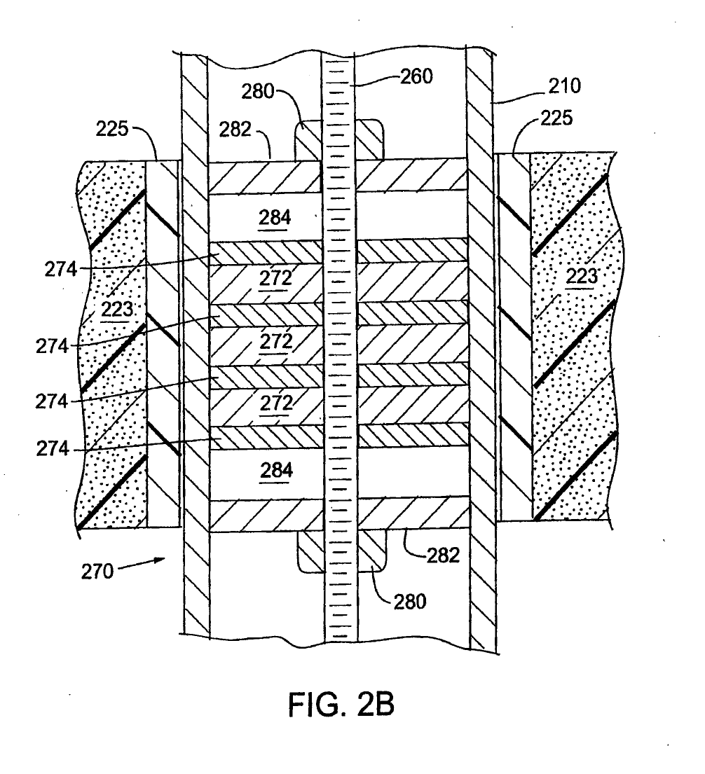

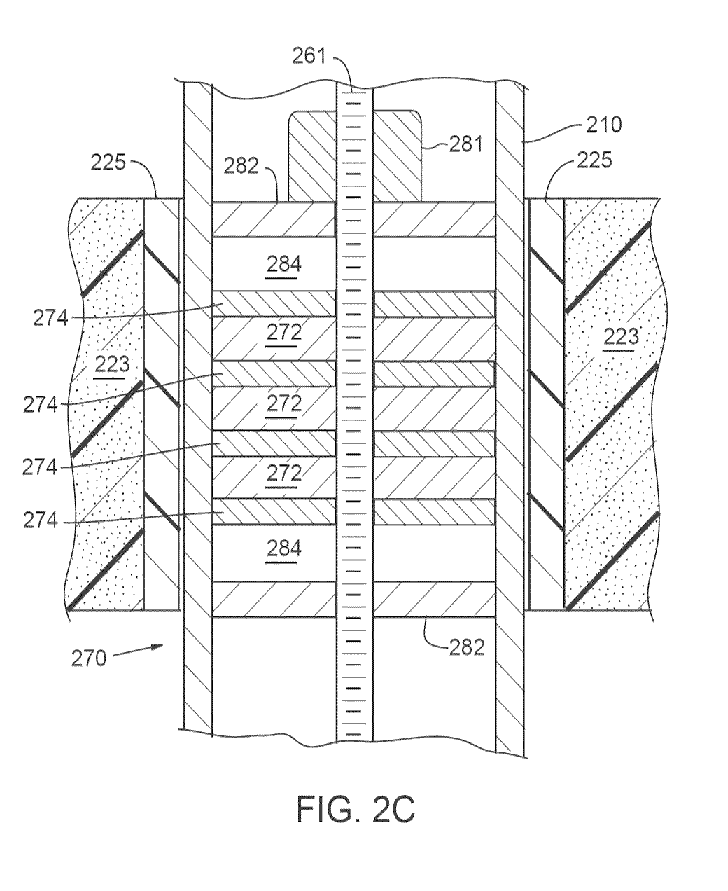

FIG. 2A shows a side cross-section view of a system 200 (taken along the lines 2A-2A indicated in FIG. 1B), which is one embodiment of the system 100 of FIG. 1. In this particular embodiment, a float 220 comprises air or other buoyant material 223 formed around a concentric cylinder 225 comprised of one or more materials (e.g., a ferrous metal such as steel, aluminum, polymer, composite). The cylinder 225 can be the same height as the buoyant material 223, or it can be taller or shorter. A spar 210 forms a cavity 215 which contains at least one ball screw 260, which can be coaxial with the spar 210. The ball screw 260 can be held in place by a cap 250 and desirably is rotatably coupled thereto by a bearing (not shown), but desirably not exposed to the exterior of the cap. In one embodiment, the cap 250 is large enough to prevent the float 220 from sliding off of the spar 210 in, for example, rough seas. A magnet piston assembly 270 is mounted on the ball screw 260. The system 200 can also comprise a wave plate 245.

FIG. 2B depicts a side cross-section view of magnet piston assembly 270 in more detail. The magnet piston assembly 270 comprises one or more permanent magnets 272. Multiple magnets 272 can be interspersed with pole pieces 274, and both are preferably concentric with the ball screw 260. It is also preferable, but not required, that the magnets 272 and pole pieces 274 be generally ring-shaped and completely encircle ball screw 260. As defined herein, a magnet 272 that is described as “ring-shaped” or as a “ring magnet” can comprise two or more magnets configured to approximate the magnetic performance of a one-piece ring magnet. FIG. 2B depicts gaps 284 between the pole pieces 274 and the harness 282. These gaps can be of varying sizes or non-existent.

Generally speaking, the magnets 272, cylinder 225 and ball screw 260 together comprise a ferromagnetic reluctance device, sometimes herein called a contact-less force transmission system (CFTS). The magnets 272 squeeze magnetic flux radially through a central pole piece into the cylinder 225. As the float 220 (and the cylinder 225) moves up and down, a reluctance force develops and is transmitted from the cylinder 225 to the magnets 272 through the magnetic field that develops between these components. By means not shown in FIG. 2B, the magnets 272 and the pole pieces 274 are mechanically connected (e.g., by welding, fasteners or other connections) to a harness 282 and one or two ball screw nuts 280. The nuts 280 are concentric with the ball screw 260. As the float 220 moves up and down, the magnet piston assembly 270 is pulled up and down, pushing or pulling the ball screw nuts 280 along the ball screw 260, causing the ball screw 260 to rotate. Linear motion is thus converted to rotary motion. Rotary motion can be converted to linear motion by generally reversing this process, e.g., by rotating the screw 260 to cause relative linear motion of the cylinder 225. In further embodiments, a contact-less force transmission system can be used that uses a rack and pinion system or hydraulic system in place of the ball screw.

Returning to FIG. 2A, the rotary motion of the ball screw 260 turns a coupling 290 and a clutch 291. The clutch 291 can be a one-way clutch or a two-way clutch that can allow for certain advantages. One such advantage can include a flywheel effect. Direct, clutchless coupling is another possible approach that can, for example, allow for greater mechanical power-to-material-utilization ratios. A plate 293 can be added to the cavity 215 to protect the coupling 290 and the clutch 291 from impact with, for example, the ball screw nut 280. Other alternative stop mechanisms can be used. The clutch 291 turns a shaft 294 on electric generator 292. Accordingly, the coupling 290 and the clutch 291 comprise one form of an exemplary power take-off (PTO) system. Although this particular embodiment depicts the coupling 290, clutch 291 and generator 292 as being at the bottom end of the spar 210, they can also be arranged at the top of the spar 210. Additionally, in the embodiment depicted in FIG. 2A, the generator 292 is small enough to fit inside the spar 210. This can allow for a greater range of travel of the float 220 along the length of the spar 210. In other embodiments, the generator 292 can be positioned outside of the spar 210. In such an embodiment, the generator 292 can have a diameter greater than that of the spar 210.

In another embodiment, the magnets 272 and the metal plates 274 are not inside the spar 210, but are integrated into the float 220 in place of the cylinder 225. The cylinder 225 is positioned in spar 210 and mechanically connected to harness 282 and ball nuts 280, approximately where magnets 272 and metal plates 274 are in the embodiment described above.

FIG. 2C depicts another embodiment of system 200. In this particular embodiment, ball screw 260 and ball screw nuts 280 are replaced with a screw shaft 261 and a roller screw nut 281, respectively. As roller screws are well known in the art, the inner workings of roller screw nut 281 are omitted from FIG. 2C. As float 220 moves up and down, magnet piston assembly 270 is pulled up and down, pushing or pulling roller screw nut 281 along screw shaft 261, causing screw shaft 261 to rotate. In one embodiment, a roller screw nut 281 is on each end of harness 282.

Similar to system 100 of FIG. 1, system 200 can contain a ballast weight 230 and can be kept in place using a tether 240. In one embodiment, sea water can be used as ballast, which can allow for tuning of the ballast weight according to output power and sea state.

As mentioned above, in some embodiments float 220 can be configured to “slip” when a force exceeding a selected threshold is applied to it. In one embodiment, a control system (not shown) can cause generator 292 to rotate ball screw 260, causing magnet piston assembly 270 to move and “reengage” cylinder 225.

Although some embodiments described in this application (e.g., system 200) feature the CFTS as part of an ocean wave energy converter, the CFTS is also more generally applicable for other applications where there is a need to translate generally linear motion to generally rotary motion, or vice versa.

### Configurations of the Contact-Less Force Transmission System Components

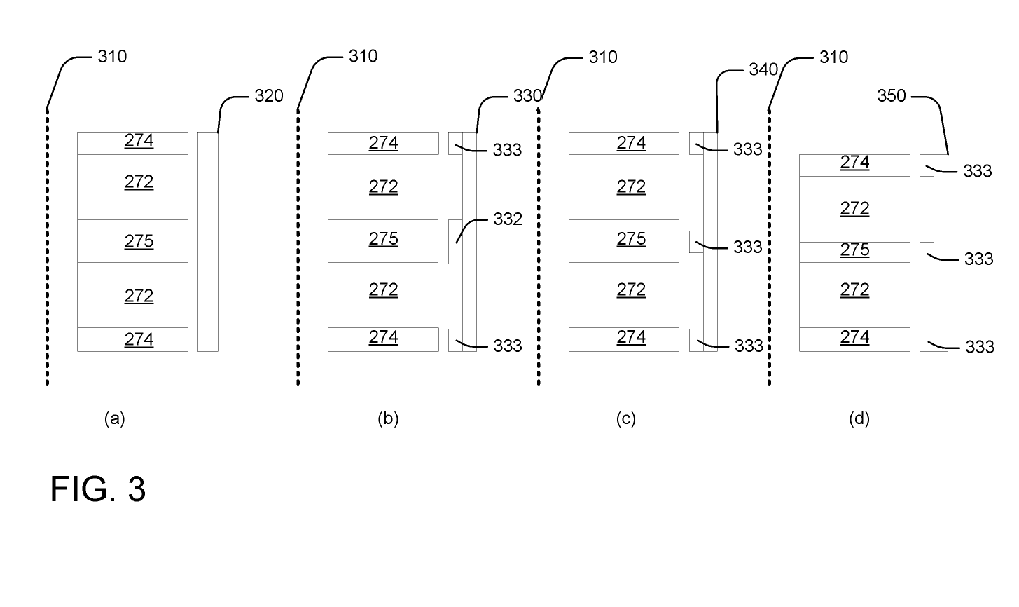

FIG. 3 shows side cross-section views of four exemplary configurations (a)-(d) for magnets 272, pole pieces 274 and cylinder 225 of system 200. Those of skill in the art will recognize other possible configurations. Each configuration depicted in FIG. 3, is shown relative to a line of axial symmetry 310 that is generally coaxial to spar 210 and ball screw 260.

Of the four designs shown, design (a) has a non-salient cylinder 320, while the other three designs have cylinders 330, 340, 350 with salients 332, 333, which are raised features protruding from the cylinders. In designs (a)-(c), the middle pole piece 275 is approximately twice as thick as the other pole pieces 274. An arrangement such as this can be used to create a symmetrical system of equal flux linkage to all phases in order to produce balanced two- or three-phase voltages. Design (d) features pole pieces 274 and middle pole piece 275 that are of approximately equal axial length. Salient 332 on cylinder 330 of design (b) is approximately twice as long (axially) as the other two salients in that design. In designs (c) and (d), salients 333 in each design are of approximately equal size.

In one group of tests conducted on these designs, it was shown that cylinders 330, 340, 350 with salients were generally better than the non-salient cylinder 320 at transmitting thrust to the magnets 272. This group of tests also showed that the thrust transmission of designs (b) and (c) were not significantly different.

In one embodiment, four ring-type, NdFeB magnets with the following dimensions were used: external diameter, 100 mm; internal diameter 50 mm; axial thickness, 25 mm. The magnets were stacked axially with soft-iron ring-shaped pole pieces 10 mm thick between them.

Finite element analysis (FEA) was conducted on designs (a)-(d). The dimensions of components modeled in the FEA are shown in Table 1 and Table 2.

TABLE 1
Dimensions of magnet and ball screw components modeled in FEA.

| | | NdFeB Magnets | | |
|---|---|---|---|---|
| Design | Diameter of | External | Internal | Axial |
| Configuration | ball screw 160 | Diameter | Diameter | Thickness |
| Design (a) | ⅜″ | 55 mm | 25 mm | 20 mm |
| Design (a), (b), | ¾″ | 100 mm | 50 mm | 25 mm |
| (c), (d) | | | | |

TABLE 2
Dimensions of pole pieces and cylinder components modeled in FEA.

| | Diam- | | | |
|---|---|---|---|---|
| | eter | | | |
| | of ball | Radial | Axial thickness | Axial thickness |
| Design | screw | thickness of | of pole piece | of middle pole |
| Configuration | 160 | cylinder 225 | 274 | piece 275 |
| Design (a) | ⅜″ | 5 mm | 5 mm | 10 mm |
| Design (a) | ¾″ | 20 mm | 10 mm | 20 mm |
| Design (b), (c) | ¾″ | 10 mm | 10 mm | 20 mm |
| Design (d) | ¾″ | 10 mm | 10 mm | 10 mm |

The results of computed force capability as functions of displacement between piston assembly 270 and cylinder 225 are given in FIG. 4. (Results for design (c) are not shown, but its performance was very similar to that of design (b).) As shown in the FEA results of FIG. 4, the peak thrust of the design (d) is higher than that of design (b). The peak thrust is obtained at a displacement approximately equal to one magnetic pole dimension. However, the thrust characteristics of design (b) are wider than that of design (d), with high thrusts distributed over a wider range of axial displacement.

The difference in the characteristics of designs (b) and (d) can be attributed to saturation of the central pole (located approximately at middle pole piece 275) in design (d) compared to design (b) and the effects of flux leakage. In design (d), the effects of saturation of the central pole make the thrust lower compared to design (b) at higher displacements. On the other hand, the relatively large middle pole piece 275 and consequently larger dimensions in design (b) allow for increased leakage which generally reduces the flux density and thrust. Depending on the required application, either curve can be chosen either to increase the peak thrust (design (d)) or to allow adequate vertical travel (design (b)). The peak thrust values of all four configurations, obtained by FEA, are compared in Table 3.

TABLE 3
Peak thrust of design configurations shown in FIG. 3.

| Design | Peak |
|---|---|
| Configuration | Thrust, N |
| Design (a) | 343 |
| Design (b) | 763 |
| Design (c) | 769 |
| Design (d) | 900 |

The results of Table 3 were compared with experimental test results to determine the peak output thrust for two different prototypes, implemented with different ball screw sizes as shown in Table 4.

TABLE 4
Comparison of peak axial thrust from FEA and experimental test data.
Peak Axial Force (N)

| | Design | FEA Model | |
|---|---|---|---|
| Prototype | Configuration | Prediction | Test |
| ⅜″ - diameter | Design (d) | 122 | 117.6 |
| ball screw 260 | | | |
| ¾″ - diameter | Design (a) | 900 | 894.3 |
| ball screw 260 | | | |

### Experimental Results of the Contact-Less Force Transmission System with Generators

Testing of one embodiment of the CFTS in system 200 was carried out by applying a known thrust to cylinder 225 and measuring the electrical output of generator 292. Two permanent magnet generators, generator #1 and generator #2, were used in testing. Parameters for generator #1 and generator #2 appear in Table 5 and Table 6, respectively.

TABLE 5
Parameters for generator #1.

| | |
|---|---|
| Manufacturer | AMETEK |
| Type | Brushless DC |
| Rated Voltage | 270 V |
| Phase | 3 |
| RPM | 12000 |
| Rs, Xs | 0.43 Ω, 0.19 Ω |

TABLE 6
Parameters for generator #2.

| | |
|---|---|
| Manufacturer | MAVILOR MOTORS |
| Type | BS073A00010T.00 |
| Phase | 3 |
| BEMF | 241 V |
| Peak Stall Torque | 13.6 Nm |
| Continuous Stall Torque | 2 Nm |
| KT | 0.71 Nm/A |
| Max RPM | 5600 |
| Insulation Class | F |
| Resolver | 2T8 |

In a laboratory setting without water, a known thrust was obtained by attaching weights to cylinder 225 and releasing it to accelerate under gravity. The speed measurement was obtained from an oscilloscope capture of the output waveform of generator 292 by measuring its frequency and using the equation for the speed of a synchronous generator

$${n}_{s} = \frac{120 f}{p} \qquad ( 1 )$$

where p is the number of poles and f is the frequency. From the calculated speed, the axial velocity was obtained from the formula

$$Ω = \frac{d z}{d t} \cdot \frac{2 π}{l} [ rad / s ] \qquad ( 2 )$$

using the lead, l, of ball screw 260, where Ω is the mechanical speed of rotation of the shaft and dz/dt is the axial velocity. Input power to this system was the product of the applied thrust and linear velocity. Output power was measured directly as the electrical power was dissipated in resistances that were connected across the generator 292.

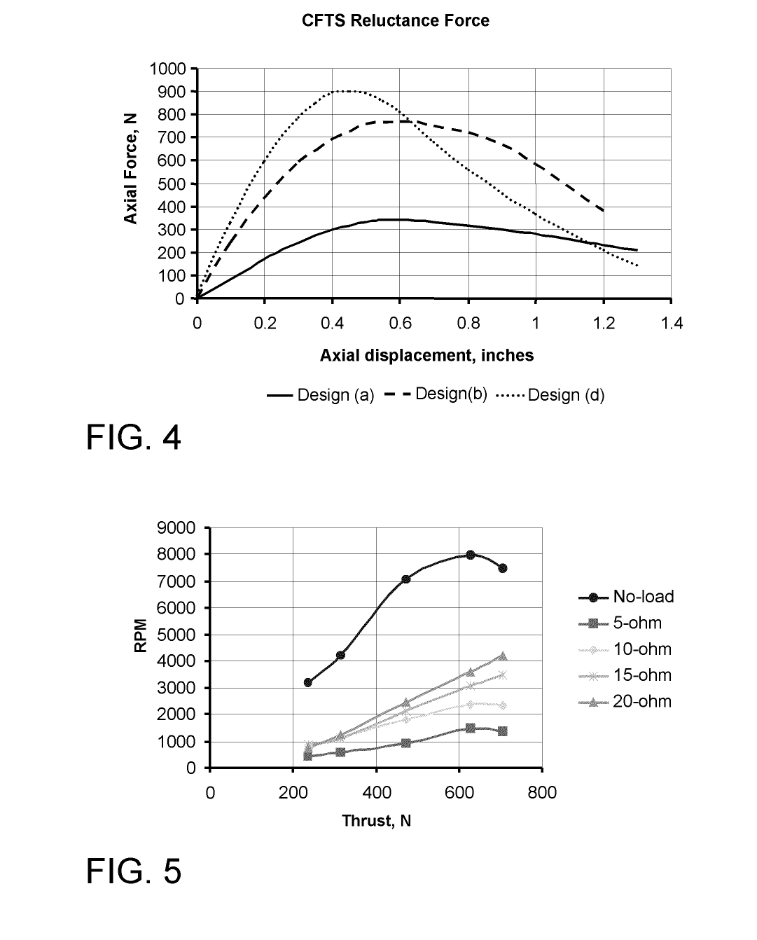

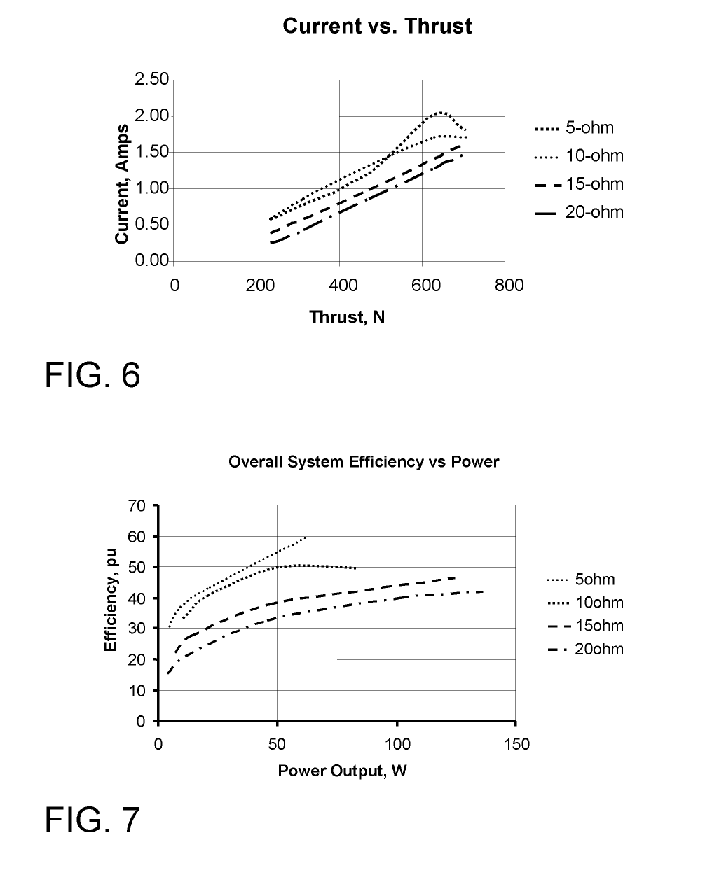

FIGS. 5-7 show test results for system 200 using generator #1. FIG. 5 shows the shaft speed of the generator under loads of 5, 10, 15 and 20 ohms and during no-load operation. Under no-load operation, the higher speeds can result in higher losses and consequently a non-linear speed-thrust characteristic. Under load, the generator speed is much lower and is more linear with thrust. The current increases fairly linearly with the applied thrust as shown in FIG. 6. As seen in FIG. 7, the overall system efficiency is greater than 50% for the 10-ohm load but falls as the electrical load is reduced. Similar curves were obtained using generator #2, except that its high impedance resulted in significant voltage drops and lower power output.

### Computer Simulation of the Buoy Generator System

The buoy generator system 200 of FIG. 2 was simulated in computer software. In this simulation, the equation of motion of the OWLC, in a single degree of freedom (SDOF) heave mode is given by

mᵥ [symbol] +b [symbol] +cz=F₀ cos(ωt+σ) (3)

where mᵥ=(m+a) is the total virtual mass of the system 200 including an added mass a; b is the damping of the buoy, comprising the hydrodynamic damping of the waves (bₗ) and the damping provided by generator 292 (b_{G}); c is the spring (buoyancy) constant; F=F₀ cos(ωt+σ) is the exciting force from the waves; z=z₀ cos(ωt) is the heave displacement. The added mass a, hydrodynamic damping bₗ, and the spring constant c are given for a cylindrical buoy by M. E. McCormick, Ocean Engineering Wave Mechanics, Wiley, 1973.

The damping constant of generator 292 can be determined from the following considerations. The relationship between the torque on the shaft T_{screw} and the axial force F_{screw} for the ball screw 260 is given by,

$$\begin{matrix}{T}_{screw} = \frac{{lF}_{scew}}{2 {πη}_{f}} ( forward driving ) & ( 4 a ) \\ {T}_{screw} = \frac{{lF}_{scew}}{2 π} {η}_{b } ( back driving ) & ( 4 b )\end{matrix}$$

where l=screw lead [m/rev], and where ρ_{f}, ρ_{b} are the forward and back drive efficiencies, respectively, of ball screw 260. Generator 292 basically acts like a brake, opposing the rotation with a torque on the shaft that can be expressed as

T_{screw}=K_{T}Ω+T₀ (5)

where T₀ is the loss torque [Nm], K_{T} is the braking coefficient of the generator [Nms/rad], and Ω is the angular velocity of the shaft. In an embodiment that uses a permanent magnet synchronous generator (PMSG), the introduction of the constant K_{T} effectively assumes a linear magnetic circuit with no saturation of the rotor and stator iron. With the relatively large effective air gaps (of the magnets themselves) that are common in PMSGs, this assumption does not usually lead to significant errors.

The total force transmitted to the PTO during an upstroke is then given by

$${F}_{screw} = \frac{2 π}{l} ( {K}_{T} Ω + {T}_{0} + {I}_{mG} α ) \qquad ( 6 )$$

where I_{mG} is the moment of inertia of the generator and shaft system, and where for the roller screw

$$Ω = \dot{z} \frac{2 π}{l} ,$$

where ż is linear velocity of ball nut 280 or, similarly, velocity of float 220. Also,

$$α = \frac{d Ω}{d t} = \ddot{z} \frac{2 π}{l}$$

is the angular acceleration of the shaft of generator 292. The generator damping coefficient is given by

$${b}_{G} = {{K}_{T} ( \frac{2 π}{l} )}^{2} \qquad ( 7 )$$

In an embodiment where generator 292 is decoupled, during the down stroke there is no axial force from the PTO on float 220. Generator 292 “free wheels,” i.e., it is decelerated by the electrical load connected to it, its own inertia and that of shaft 294 through the unidirectional clutch 291. In that case, F_{screw}=0 or,

I_{mG}α+T_{screw}=0 (8)

FIG. 8 depicts an equivalent circuit of the PMSG. The voltage across a phase of the generator windings can be expressed as

$${v}_{j} = - {r}_{j} {i}_{j} + {L}_{j} \frac{d {i}_{j}}{d t} + \frac{d {λ}_{jf}}{d t} , \qquad ( 9 )$$

where rⱼ is the phase resistance, iⱼ is the current of j-th phase, λ_{jf} is the flux linkage in phase j due to the permanent magnet, and Lⱼ is phase inductance.

The peak value of the induced emf of the PMSG is dependent on speed and can be expressed as

$${E}_{j} = \frac{d {λ}_{jf}}{d t} = {K}_{f} \cdot Ω .$$

The currents can be obtained by rearrangement and integration of Equation 9, noting that v₁=i₁R_{load}.

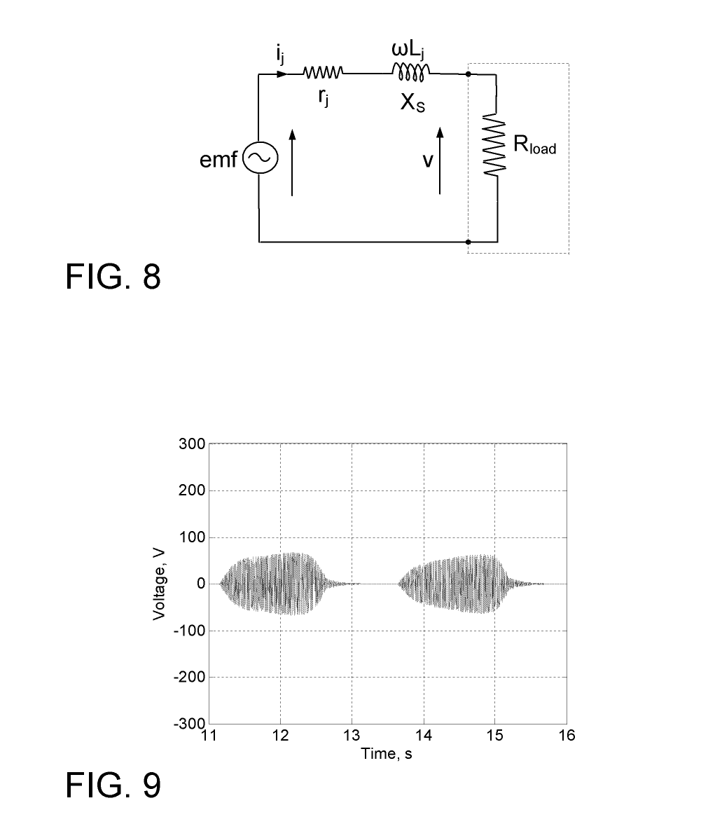

FIG. 9 shows a graphs of simulated results for the no-load voltage of generator 292 during operation in waves with a unidirectional clutch action on shaft 294 under wave conditions where the wave period T=2.5 s and the significant wave height Hₛ=0.15 m. During free-wheeling, the voltage produced is zero as clutch 291 disengages generator 292 from the rotation and generator 292 is decelerated. Also, unlike operation under the reciprocating action, with a clutch the voltage time area is generally less symmetrical.

### Wave Flume Testing of the Buoy Generator System

System 200 (with a ¾″-diameter ball screw 260) was tested in a wave flume. The wave flume that was used is 7 feet deep, 30 feet wide, 110 feet long and tapers to a typical beach. There are two sets of hydraulically driven wave makers that are activated in sequence to create irregular waves of approximately 4 feet in height and with approximately four-second dominant periods. System 200 was tested in irregular waves. This particular embodiment was made up of system 200, with the addition of a rigid shaft between spar 210 and a mooring plate. The shaft was also equipped with a swivel joint that allowed motion in six degrees of freedom. However, the threaded studs of the swivel joint were adjustable to provide a stiff rigid member. For this embodiment, spar 210 is about 1.68 m (5.5 feet) long, and float 220 has an outer diameter of about 0.6 m and is about 0.6 m long.

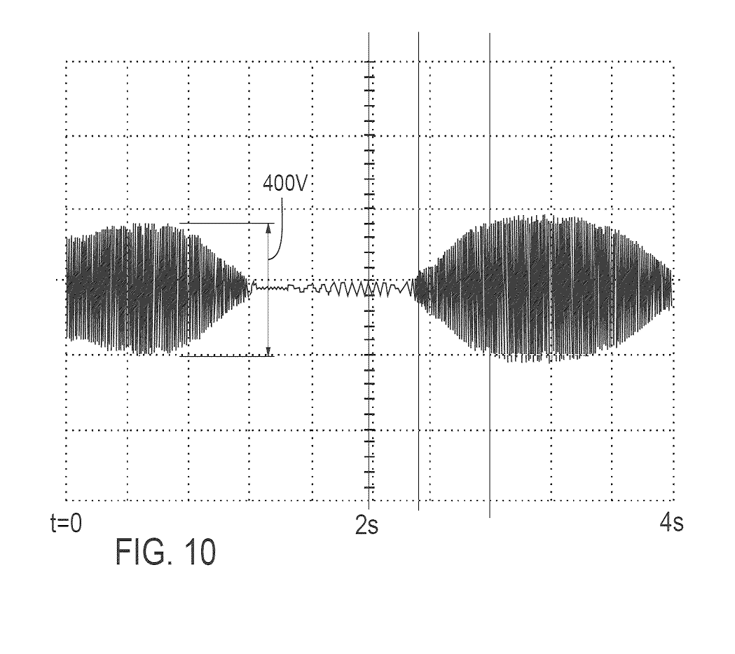

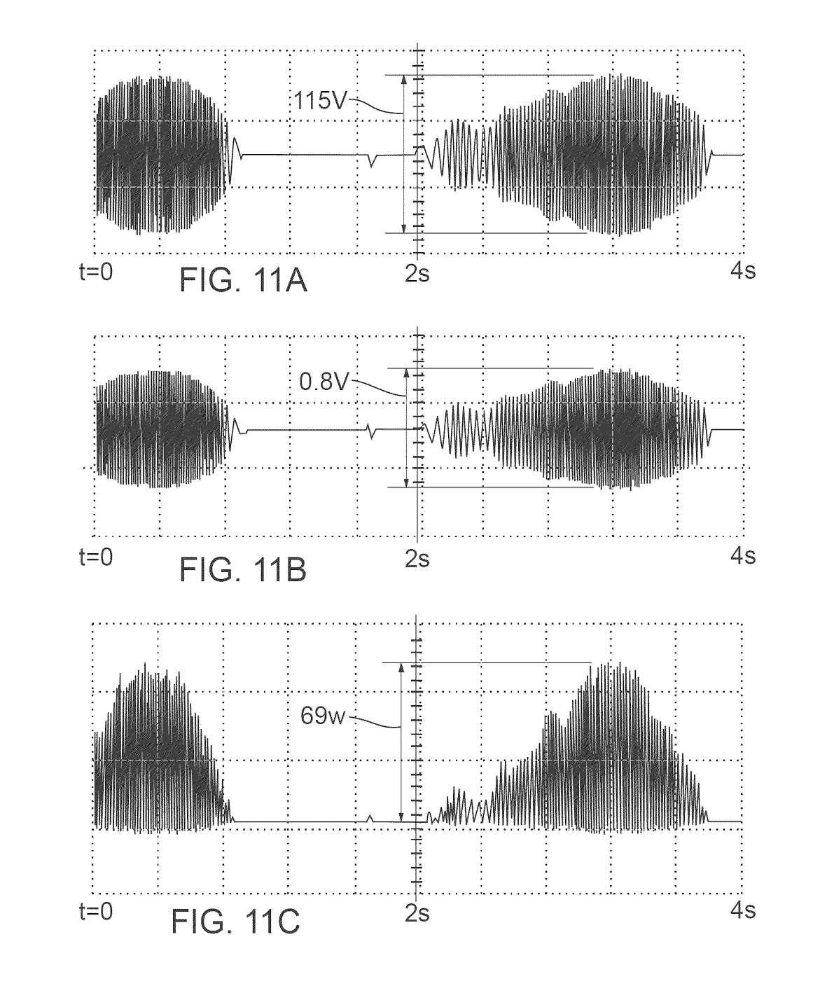

FIG. 10 is an oscilloscope capture showing the no-load voltage output of generator 292 during the up-stroke and down-stroke portions of the wave cycle. Because clutch 291 was uni-directional in this tested embodiment, generator 292 free-wheels on the down stroke and no voltage is generated. FIGS. 11A-11C show example oscilloscope captures of system 200 operating into a 75-ohm load. FIGS. 11A-11C show waveforms for voltage, current, and power outputs, respectively. The peak output power under load was about 69 W. The generator used in the tested embodiment (generator #1) has a high synchronous reactance and a high voltage drop. A generator model of relatively lower impedance can improve output power.

Wave flume test results for generator outputs under various load conditions are summarized in Table 7.

TABLE 7
Wave flume test results.

| Load | | | |
|---|---|---|---|
| Resistance | Voltage | Current | Power |
| ohm | (Vp) V | (Ip) A | (Wp) W |
| 20 | 16 | 0.5 | 6 |
| 30 | 35 | 0.7 | 18.4 |
| 50 | 52 | 0.6 | 23.4 |
| 75 | 65 | 0.6 | 29.3 |

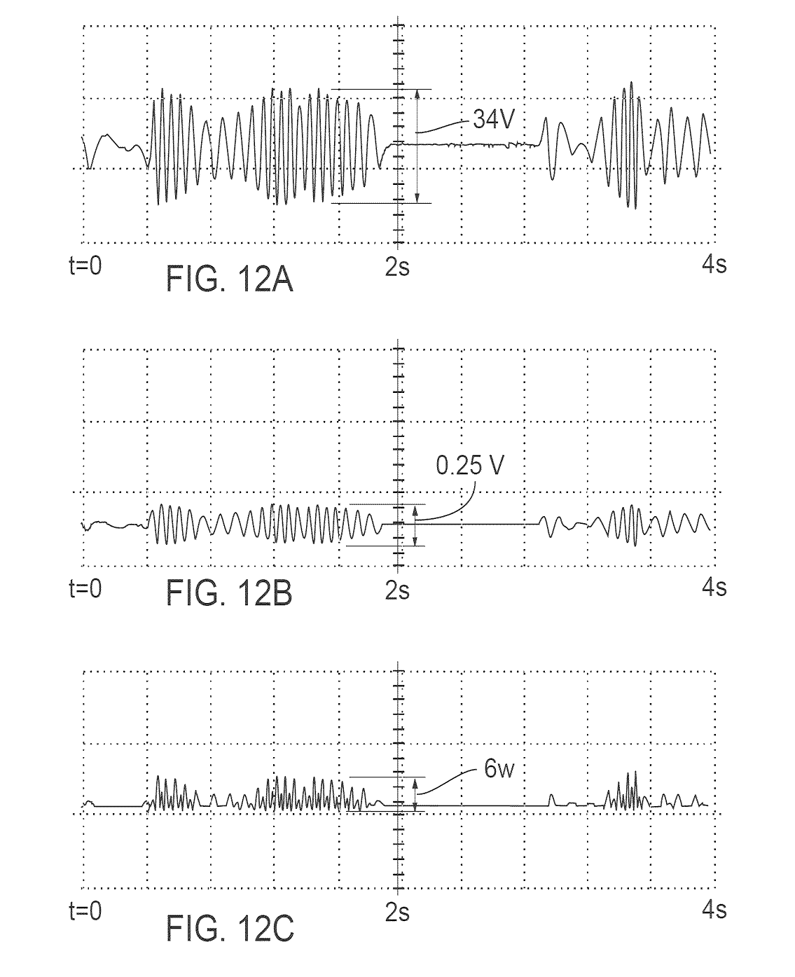

FIGS. 12A-12C show waveforms (for voltage, current, and power, respectively) caused by irregular motion of spar 210 due to irregular wave excitation. In another embodiment, these effects are reduced using a dynamic control system.

### System Using a Permanent Magnet Helical Screw Drive

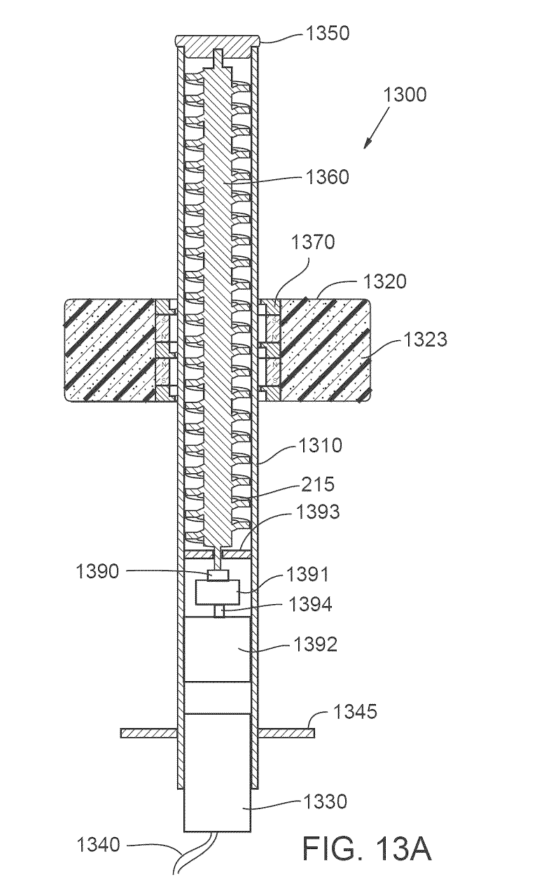

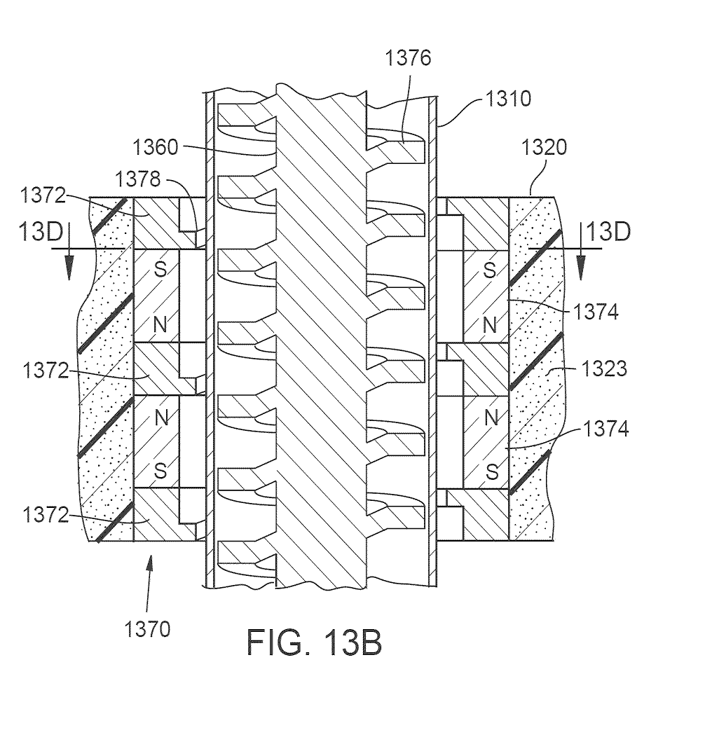

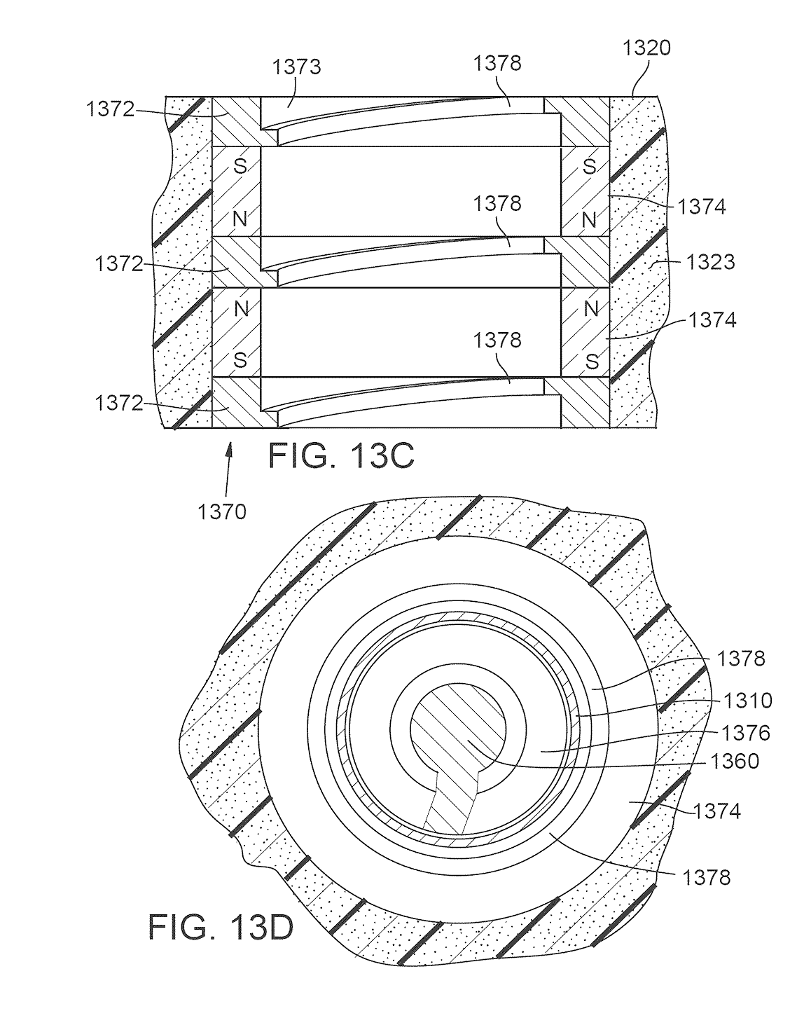

FIG. 13A shows a cross-section side view of another exemplary embodiment of system 100. System 1300 comprises a float 1320 which is approximately coaxial with a tube-like spar 1310. Float 1320 comprises air or other buoyant material 1323 and a magnet assembly 1370, which is described in more detail below. Float 1320 preferably encircles spar 1310 a full 360 degrees, but it can also encircle spar 1310 less than 360 degrees. Similar to other embodiments described above, spar 1310 can be comprised of a material that can withstand ocean conditions for a relatively long period of time, such as PVC, fiberglass, or composite material. System 1300 can further comprise a cap 1350, a generator 1392 with a shaft 1394, a clutch 1391 (uni- or bi-directional), a coupling 1390, a protective plate 1393, a ballast weight 1330, and a wave plate 1345. System 1300 can be secured to an anchor or mooring system by a tether 1340. Spar 1310 contains at least one center screw 1360, which is preferably approximately coaxial with spar 1310. Center screw 1360 can be comprised of one or more materials that exhibit high electrical resistance and low magnetic reluctance, such as a steel alloy comprising about 1-4% silicon. As is known in the art, what constitutes “high electrical resistance and low magnetic reluctance” varies from application to application.

FIG. 13B shows center screw 1360 and surrounding magnet assembly 1370 in more detail. Center screw 1360 comprises threads such as thread 1376, which desirably run at least part of the length of center screw 1360. The threads can have a flat face (i.e., outer surface) and a vertical wall angle, although other face designs and wall angles can also be used. Characteristics of threads 1376 (e.g., pitch, spacing) can be chosen based on a particular application. A choice of thread pitch can be weighed against thrust and speed requirements of system 1300.

FIG. 13C shows magnet assembly 1370 in more detail, without spar 1310 and center screw 1360. Magnet assembly 1370 comprises two or more pole shoes 1372, which are arranged generally concentrically with spar 1310. Pole shoes 1372 can comprise a generally circular or generally semi-circular main piece 1373 and can have a thread 1378 extending along part or all of the inside of main piece 1373. Pole shoes 1372 and threads 1378 can extend 360 around the inside of float 1320, or they can extend less than 360 degrees around. In one embodiment, a pole shoe 1372 can be comprised of two or more pole shoe pieces of smaller angular size. The pole shoe pieces can be placed adjacent to each other in an axial plane or, if their size permits, they can be placed non-adjacent in an axial plane. For example, a pole shoe which extends 360 degrees can be comprised of two 180-degree shoes. Pole shoes 1372 are comprised of one or more materials that exhibit high electrical resistance and low magnetic reluctance, such as a silicon iron alloy. Characteristics of threads 1378 (e.g., pitch, spacing) can be chosen based on a particular application. Pitch of threads 1376 can be selected to amplify or reduce the angular speed of a turning center screw 1360. A choice of thread pitch can be weighed against thrust and speed requirements of system 1300. Preferably, between two pole shoes 1372 is a ring magnet 1374. One or more pairs of ring magnets 1374 can be used to create complementary flux densities. In one embodiment, several ring magnets 1374 are stacked axially adjacent to each other with their poles in the same orientation. If desired, threads 1378, ring magnets 1374 and pole shoes 1372 can be coated with an insulator, preferably a non-conductive, corrosion-resistant, high-strength, non-magnetic insulation (not shown).

FIG. 13D depicts a top cross-sectional view taken along the line 13D-13D indicated in FIG. 13B. This embodiment shows ring magnet 1374 and the threads 1378 from two 180-degree pole shoes 1372. (In this view, ring magnet 1374 hides most of the pole shoes 1372 except for threads 1378.)

Returning to FIG. 13A, when relative linear motion occurs between float 1320 and spar 1310 (e.g., when a wave exerts a force on float 1320), magnet assembly 1370 moves in a linear direction relative to center screw 1360. This causes a differential in magnetic flux between center screw 1360 and pole shoes 1372. This differential flux can result in transaxial forces which pull on screw 1360, causing it to rotate back into alignment with pole shoes 1372. This can create relative rotary motion between center screw 1360 and magnet assembly 1370. As a result, center screw 1360 turns shaft 1394 on generator 1392, creating an electric current. The electric current can be created in, for example, the forward and/or reverse directions.

In particular embodiments, both the screw and nut assembly can be contained within the spar 1310 (e.g., entirely within the spar), and the driving force from the buoy 1320 can be coupled to the nut and screw assembly through a mechanical linkage between the spar 1310 and the buoy 1320.

Generally, center screw 1360 and magnet assembly 1370 can operate bi-directionally. For example, rotary motion can be converted to linear motion by applying a torque to center screw 1360 or magnet assembly 1370 (or to both). This rotary motion can cause a differential flux (similar to that described above) resulting in a linear motion.

Although the magnet assembly 1370 and center screw 1360 are described above with respect to an ocean wave energy converter, this combination can be used more generally for applications involving a conversion between linear motion and rotary motion. For example, many applications currently using ball screw assemblies can be redesigned using a magnet assembly 1370 and center screw 1360. This approach can allow for: less acoustic noise (particularly for operations at relatively high speeds); less wear and maintenance; recovery from overloads with little or no maintenance; amplification of speed or torque (depending upon a screw thread pitch); and improvements in energy transfer efficiency, as losses can generally be limited to radial bearing friction and magnetic hysteresis losses.

### System Featuring Multiple Spars

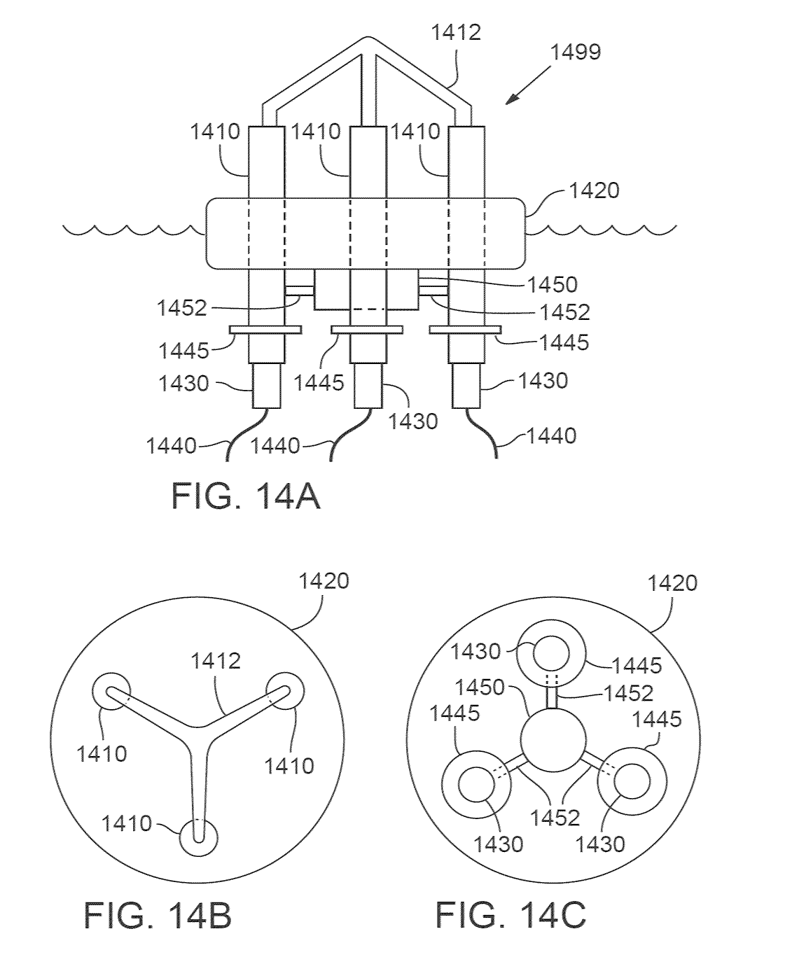

FIG. 14A depicts an ocean wave energy converter system 1400, which comprises a float 1420 and two or more spars 1410. The particular embodiment shown features three spars 1410 surrounded by float 1420. Spars 1410 are reinforced from above by support structure 1412, but in other embodiments a support structure on the underside of system 1400 can be added. In another embodiment no support structure is present. Spars 1410 and float 1420 together comprise systems similar to those described previously in this application, e.g., system 200 using the CFTS with either a ball screw or a roller screw, or system 1300 using permanent magnets and the helical center screw. Similar to other embodiments described above, ballast weights 1430 and wave plates 1445 can be attached to spars 1410, and the spars can be held in place using tethers 1440. The top ends of the spars 1410 can have caps as in other embodiments, although they are not shown in FIG. 14A.

In one embodiment, individual spars 1410 contain a generator (not shown), similar to the systems described above. In another embodiment, spars 1410 transfer rotary energy through a gear system 1452 (or other energy transmission system) to turn a generator 1450. Harnessing the rotary energy from two or more spars can allow for improved scalability of a multiple-spar system and can also allow for higher generator speeds.

FIG. 14B provides a top view of system 1400, showing float 1420, spars 1410 and support structure 1412. FIG. 14C is a bottom view of system 1400, showing generator 1450 and gear system 1452, as well as float 1420, ballast weights 1430 and wave plates 1445.

### Exemplary Embodiments of a Magnetic Helical Screw Drive

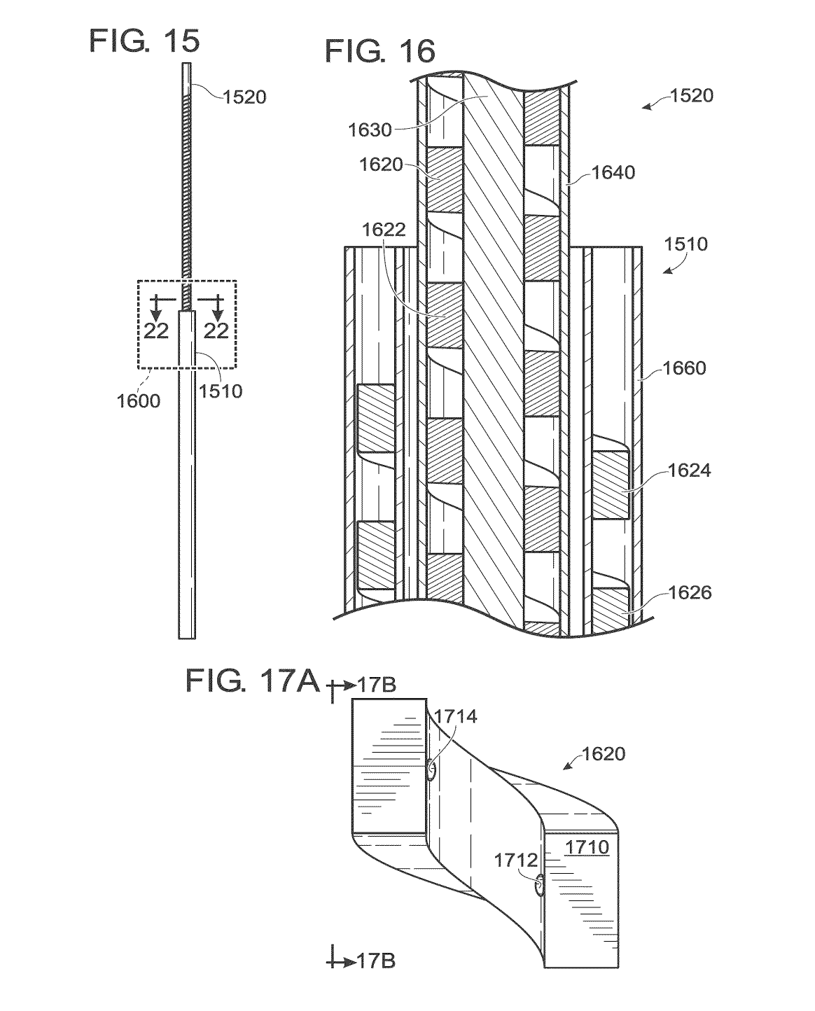

FIG. 15 shows components that can be used with, for example, further embodiments of the system 1300 or, more generally, with systems for converting between linear motion and rotary motion. For example, an elongated inner member (such as a screw 1520) can be slidably received by an outer member (such as a nut 1510). In some embodiments, the screw 1520 and the nut 1510 can be used, for example, in place of the magnet assembly 1370 and the center screw 1360, respectively. The nut 1510 can move linearly or generally linearly relative to the screw 1520. In further embodiments, the nut 1510 can move generally rotationally relative to the screw 1520. As was similarly explained above for the magnet assembly 1370 and the center screw 1360, magnetic interactions between the nut 1510 and the screw 1520 can cause the nut 1510 and the screw 1520 to rotate relative to each other. Thus, the components of FIG. 15 can be used to convert linear motion to rotary motion, and vice versa. In some embodiments, a float similar to float 1320 or a waveplate can be coupled to the nut 1510, and the screw 1520 can be coupled to a generator similar to generator 1392. In at least some such embodiments, as the nut 1510 moves linearly relative to the screw 1520 (e.g., as a result of a wave exerting a force on a float or waveplate coupled to the nut 1510, or as the result of another force), the screw 1520 rotates and causes the generator to generate an electric current. In further embodiments, a float or waveplate is coupled to the screw 1520 and a generator is coupled to the nut 1510. In such embodiments, as the screw 1520 moves linearly relative to the nut 1510, the nut 1510 rotates and causes the generator to generate an electric current.

Although the exemplary embodiments of the nut 1510 and the screw 1520 are depicted herein as being generally cylindrical in shape with generally circular cross-sections, the nut 1510 and/or the screw 1520 can have other shapes, as well. For example, the nut 1510 and/or the screw 1520 can have a shape with a polygonal cross-section (e.g., three, four, five, six, seven, or more sides, the sides being of equal lengths or of varying lengths). Generally, the respective shapes of the nut 1510 and the screw 1520 can be such that at least one of these components can rotate relative to the other. In further embodiments, at least one of the nut 1510 and the screw 1520 are curved such that these components travel an arcuate path relative to each other. Such arcuate motion is considered to fall within “linear motion” (e.g., as in “converting between linear motion and rotary motion”).

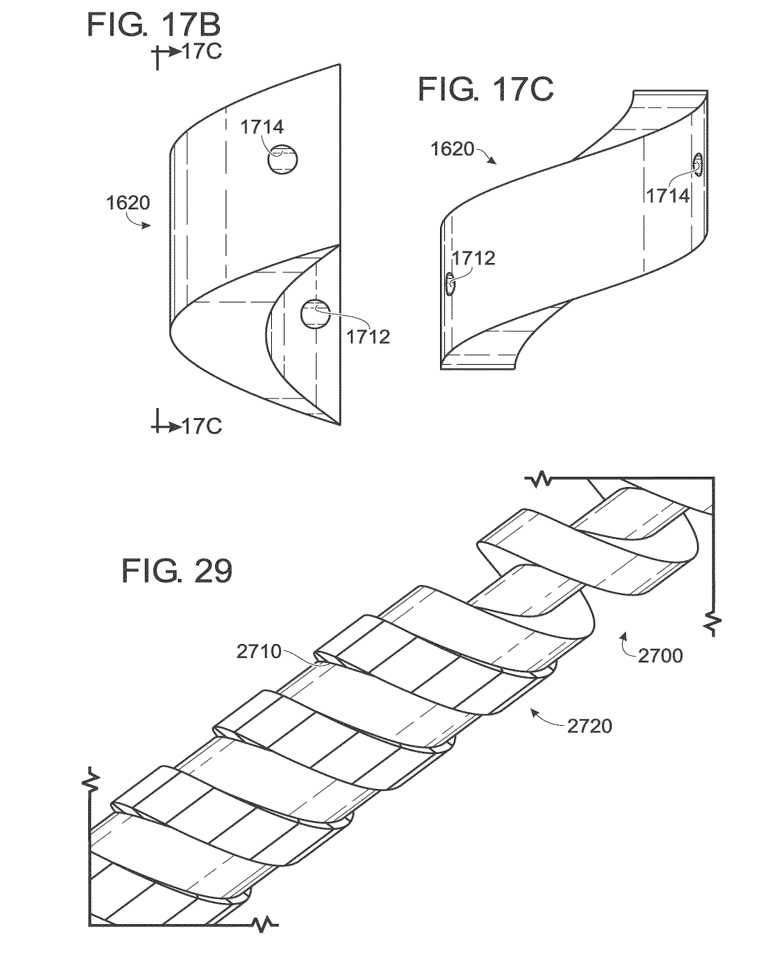

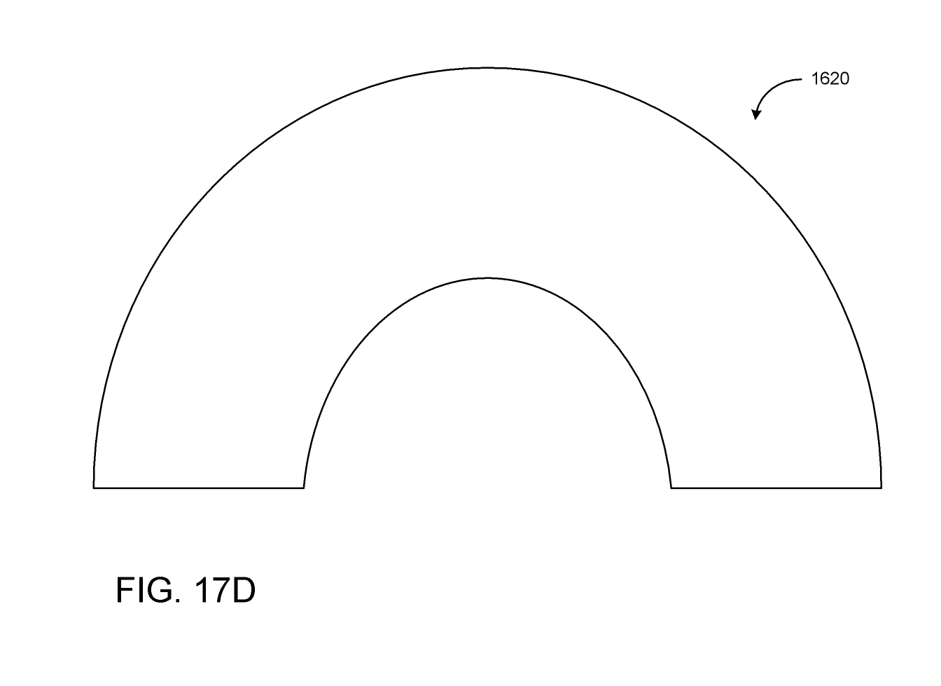

FIG. 16 shows a cross-sectional side view of one embodiment of a portion 1600 of the nut 1510 and the screw 1520. In the depicted embodiment, the screw 1520 comprises a plurality of magnet segments (e.g., permanent magnets and/or electromagnets), such as magnets 1620, 1622. The magnets 1620, 1622 are arranged in a generally helical configuration. FIG. 17A shows a front view of one embodiment of a form of magnet 1620. The depicted embodiment comprises a rectangular cross-section 1710, but other cross-section shapes can be used. Additionally, the magnet 1620 can extend in an arc-like or a wedge-like shape (for example, as a section of a torus or ring) through a varying number of degrees (e.g., 20 degrees, 30 degrees, 45 degrees, 60 degrees, 90 degrees, 180 degrees, 240 degrees, 270 degrees, 360 degrees, or any other number of degrees, including approximately any of the foregoing numbers of degrees). Such magnets are described herein as having an “angular width” of a certain number of degrees (e.g., “an angular width of 30 degrees”). In some embodiments the magnet 1620 comprises one or more subsections, which can be straight, curved, or a mixture of both. Other magnet shapes can be used, as well. In particular embodiments the magnet 1620 comprises one or more receptacles 1712, 1714 for fasteners to secure the magnet 1620. The receptacles 1712, 1714 can be, for example, threaded or unthreaded screw holes. FIG. 17B shows a side view of the form of magnet 1620 of FIG. 17A, while FIG. 17C shows a back view of the form of magnet 1620. FIG. 17D shows a top view of this form of magnet 1620.

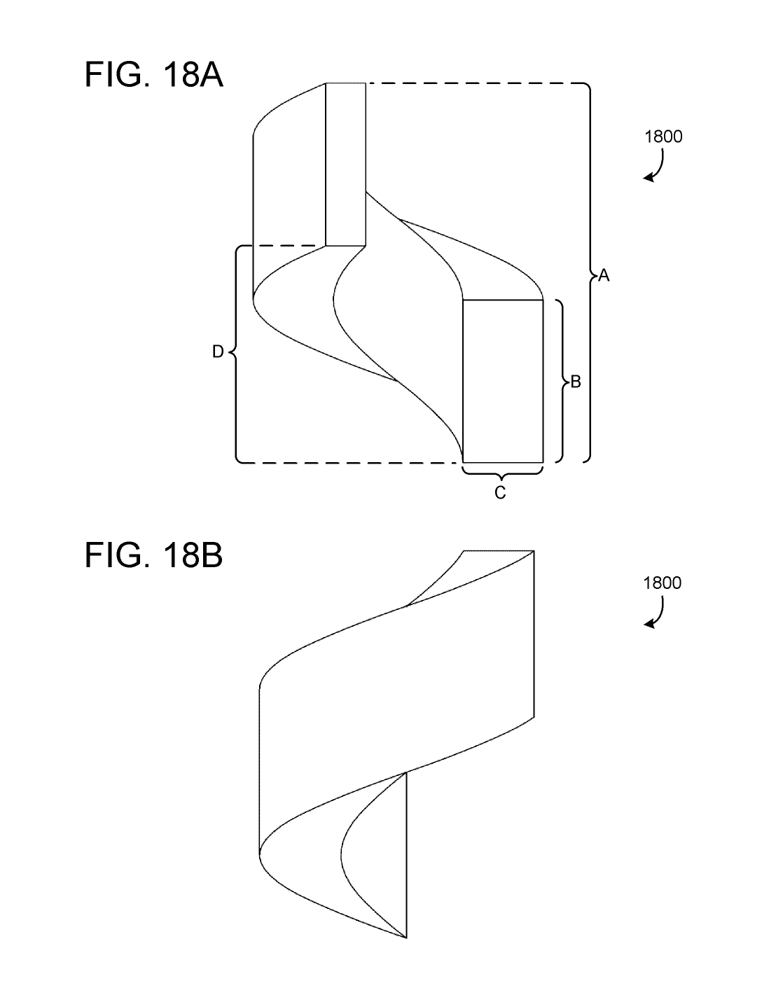

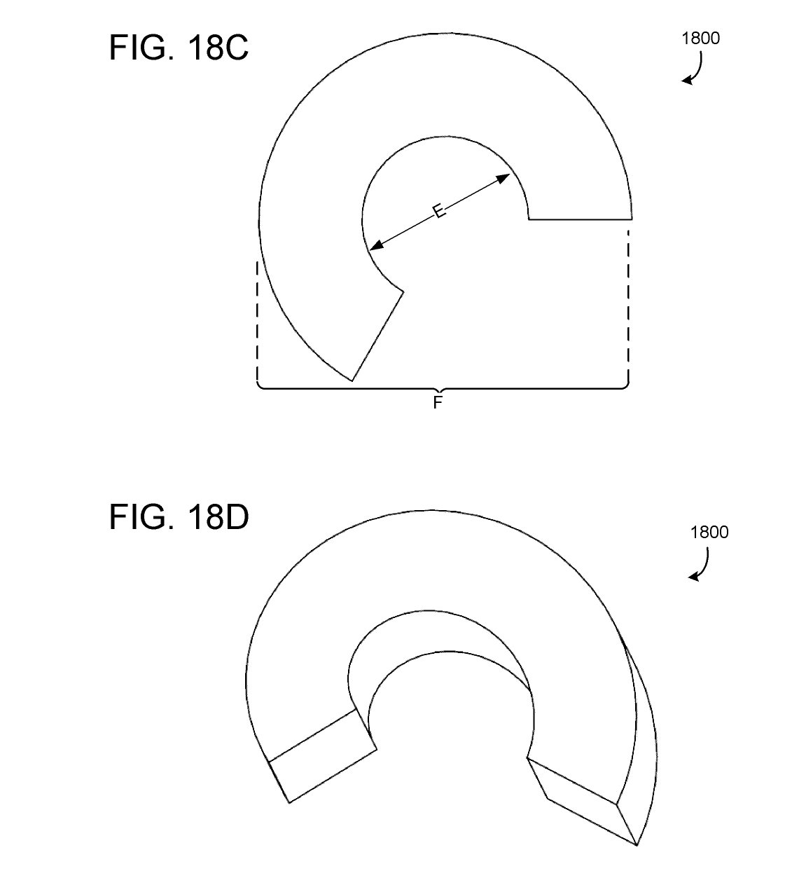

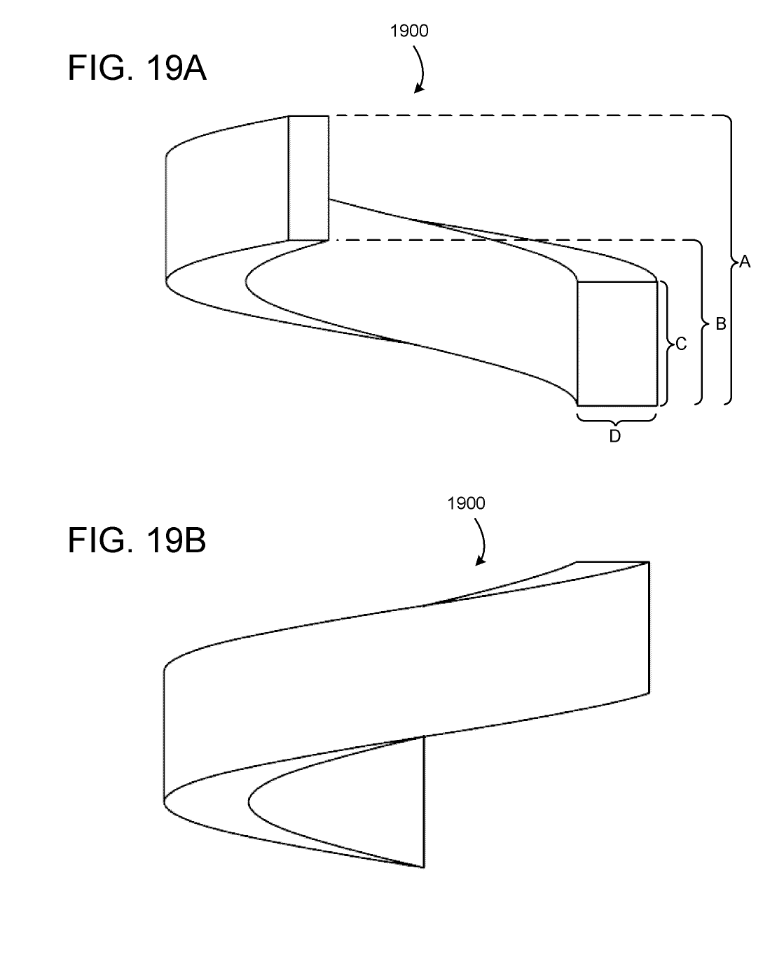

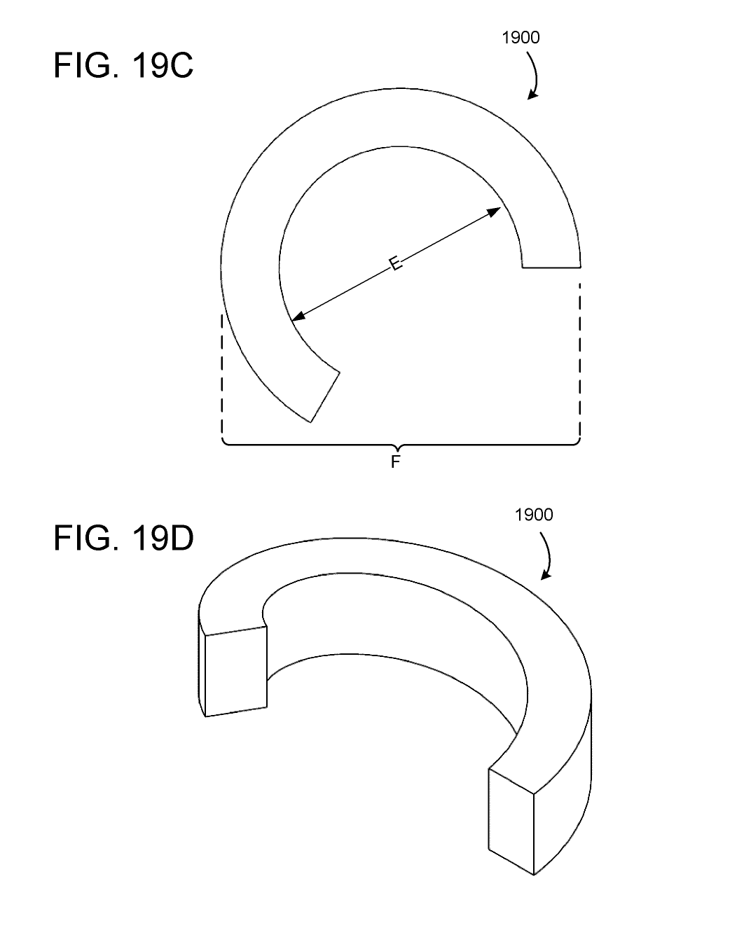

In at least some embodiments, the use of magnet sections in arc-like or wedge-like shapes that exceed 180 degrees (e.g., approximately 240 degrees, as well as arc-like or wedge-like shapes of other numbers of degrees) can allow for improved assembly procedures by allowing the magnet to be axially fixed to a magnet support (e.g., a scaffold having a circular cross-section, polygonal cross-section, or other cross-section) with limited additional support. For example, FIG. 18A shows a front view of an exemplary embodiment of a magnet 1800 for use with, for example, a screw (e.g., the screw 1520). The magnet 1800 has an arc shape of approximately 240 degrees. FIGS. 18B-D show, respectively, rear, plan and perspective views of the magnet 1800. As another example, FIGS. 19A-D show, respectively, front, rear, plan and perspective views of an exemplary embodiment of a magnet 1900 for use with, for example, a nut (e.g., the nut 1510). The magnet 1900 has an arc shape of approximately 240 degrees. Exemplary measurements for dimensions indicated in FIGS. 18A-D and 19A-D appear below in Tables 8 and 9, respectively. Further embodiments can use other dimensions.

TABLE 8
Dimensions for Magnet 1800

| Dimension | Length (mm) |
|---|---|
| A | 18.67 |
| B | 8 |
| C | 3.93 |
| D | 10.67 |
| E | 6.35 |
| F | 14.2 |

TABLE 9
Dimensions for Magnet 1900

| Dimension | Length (mm) |
|---|---|
| A | 18.67 |
| B | 10.67 |
| C | 8 |
| D | 5.13 |
| E | 21.35 |
| F | 31.6 |

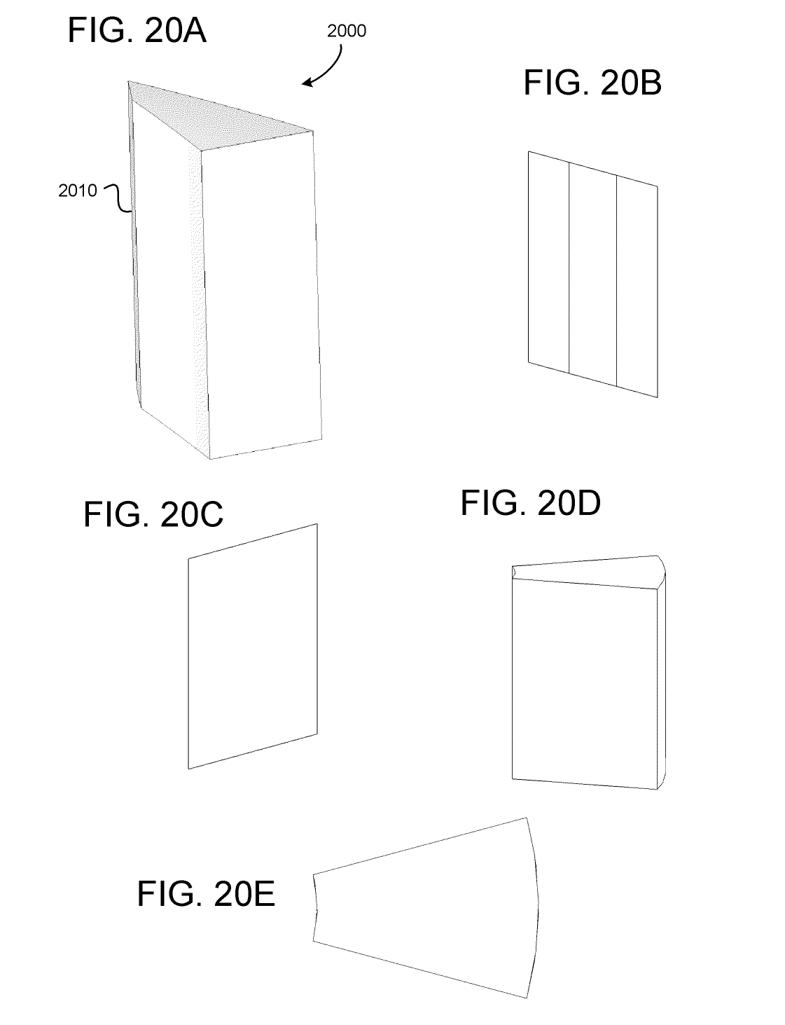

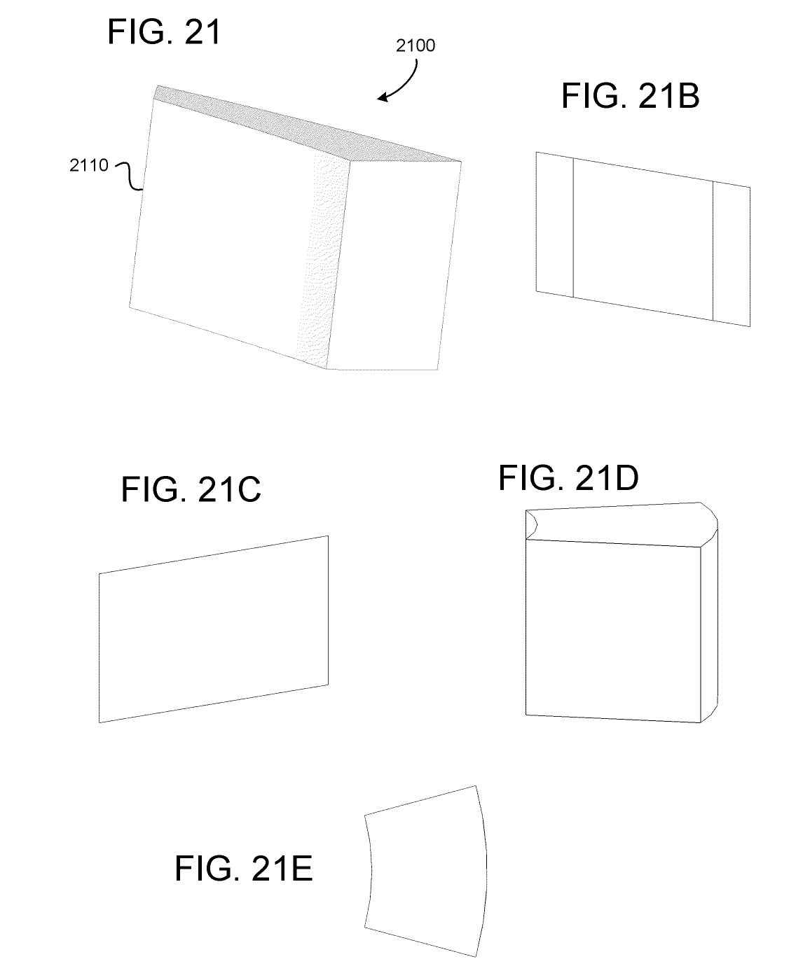

FIGS. 20A-E and 21A-E show various views of exemplary embodiments of, respectively, a magnet 2000 and a magnet 2100. FIGS. 20A-E show, respectively, perspective, back, front, side and top views of the magnet 2000. FIGS. 21A-E show, respectively, perspective, back, front, side and top views of the magnet 2100. These magnets have arc-like or wedge-like shapes of approximately 30 degrees. The magnet 2000 comprises an angled face 2010 at the back of the magnet; the magnet 2100 comprises an angled face 2110 at the back face of the magnet. In various embodiments, each of the magnets 2000, 2100 can be used in a nut component or a screw component, or in both. In particular embodiments, the magnet 2000 can be used in a screw component, and the magnet 2100 can be used in a nut component.

Magnets used in a given nut or screw component are, in some embodiments, of a uniform size. In further embodiments, magnets used in a given screw or nut component have two or more different sizes.

Returning to FIG. 16, in some embodiments the magnets 1620, 1622 can be secured to an inner magnet support (for example, a tube or rod 1630) and/or to an outer magnet support (for example, outer tube 1640). The magnets 1620, 1622 can be secured using, for example, fasteners extending through or into the one or more receptacles 1712, 1714, as shown in FIG. 17A. Additionally, as further described below, in some embodiments a magnet support comprising a scaffold and shaped to receive the magnet sections can improve the assembly process by providing a fixture point for the magnets. The scaffold can be comprised of, for example, one or more materials such as polymers, composites, non-magnetic materials, magnetic materials, and metallic alloys. In some embodiments, the scaffold comprises non-magnetic material with selectively placed ferrous material for control of magnetic flux distribution. Although at least some embodiments depicted herein show tubes or rods comprising circular cross-sections, further embodiments comprise a tube or rod having a non-circular cross-section (e.g., polygonal or cross-shaped).

In the depicted embodiment, the magnets 1620, 1622 together extend about a 360-degree arc around a longitudinal axis of the tube or rod 1630 such that the magnets 1620, 1622 form a portion or segment of a helix (e.g., a continuous helix) along at least some of the length of the screw 1520 (e.g., along the full length or almost the full length of the screw). In further embodiments, the magnets 1620, 1622 do not fully surround or encompass the tube or rod 1630. In additional embodiments, the magnets 1620, 1622 form a non-curved line that approximates a portion or segment of a helix. In some cases, the magnets 1620, 1622 can form a continuous portion of a helix, a plurality of disconnected helical portions, and/or one or more portions of a multiple helix (e.g., a double helix, a triple helix).

As shown in FIG. 16, at least some embodiments of the nut 1510 comprise a plurality of magnets 1624, 1626 secured to one or more magnet supports that can comprise, for example, an inner tube 1650 and/or an outer tube 1660. The magnets 1620, 1622 of the screw 1520 can be structurally similar to the magnets 1624, 1626 of the nut 1510, though their relative sizes can be different. In further embodiments, at least some magnets of the screw 1520 are structurally dissimilar from the magnets of the nut 1510. Generally, the magnets can be configured to form a helical thread; however, in various embodiments the cross-section of the thread can take various aspect ratios depending on the design requirements of the screw. As a specific example, cross-sections of magnets attached to the screw can be rectangular, while cross-sections of magnets attached to the nut can be square-shaped, or vice versa. Magnets having other cross-section shapes (e.g., trapezoidal) can also be used.

In some embodiments, the force of one or more of the magnets 1620, 1622, 1624, 1626 can be improved by placing one or more ferrous materials (e.g., iron) on or near the back of one or more of these magnets. The ferrous materials can be incorporated into, for example, the tube or rod 1630 in the screw 1520 and/or into the outer tube 1660 of the nut 1510.

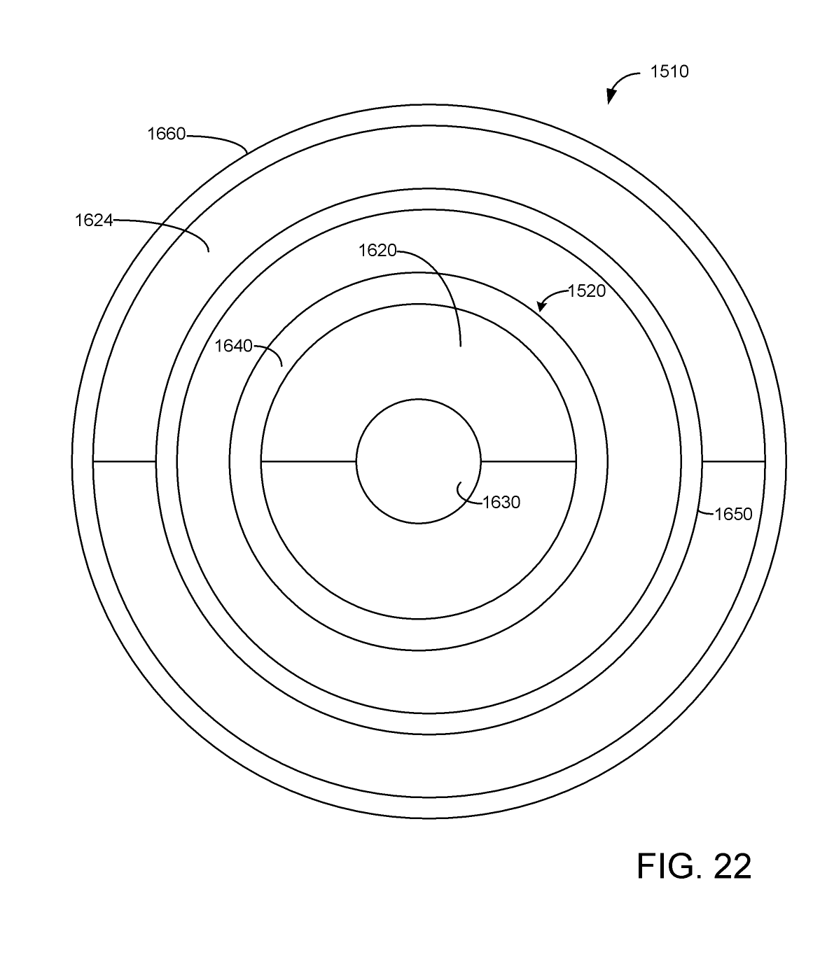

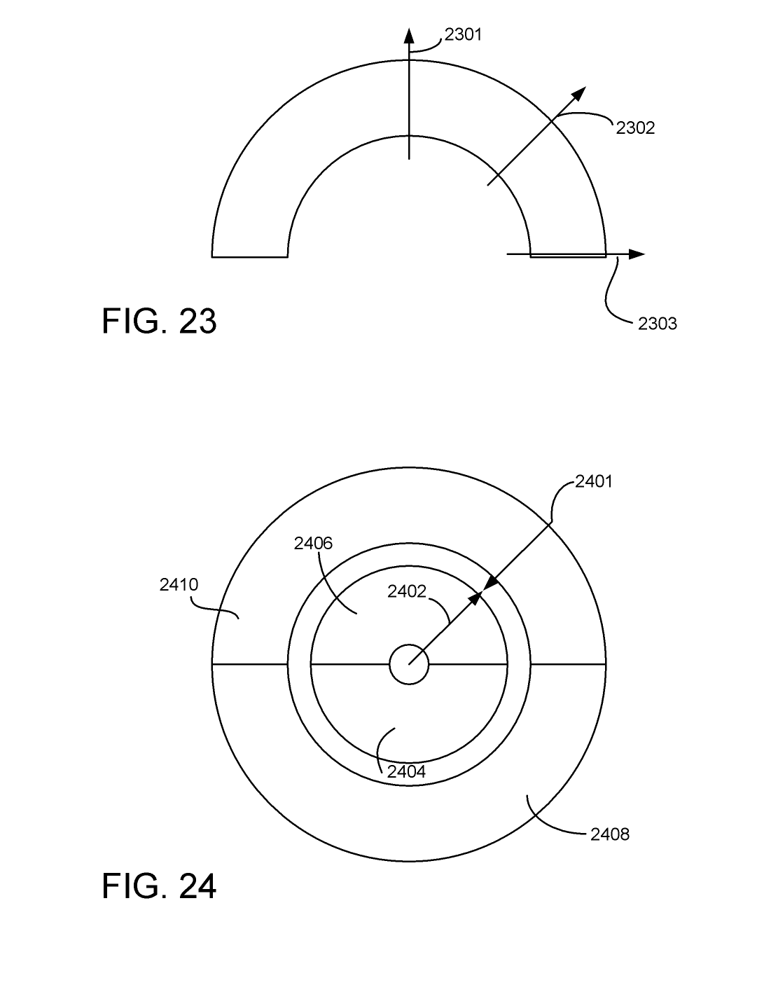

FIG. 22 is a horizontal sectional view, taken along line 22-22 of FIG. 15. FIG. 23 shows the magnet of FIG. 17D overlaid with exemplary arrows 2301, 2302, 2303 showing an example of how this particular magnet can be magnetized (e.g., polarized). In other words, the arrows 2301, 2302, 2303 show how the north-south poles of the magnet can be oriented. FIG. 24 shows the magnets of FIG. 22 overlaid with exemplary arrows 2401, 2402 showing an example of how these magnets can be magnetized. Generally, the magnets of the nut 1510 and the screw 1520 are magnetized and configured such that magnetic repulsion or attraction causes the nut 1510 to rotate relative to the screw 1520 when the nut 1510 and the screw 1520 undergo relative linear motion. In at least some embodiments, a configuration employing magnetic repulsion between the screw 1520 and the nut 1510 can allow for the screw 1520 to be self-centering or relatively self-centering with the nut 1510. This can potentially reduce or eliminate the radial bearing load and/or stiffness requirements of the screw 1520. Also, a repulsion configuration can potentially limit the changing magnetic field primarily to the air gap between magnets. This can potentially reduce hysteresis losses. Power coupling for a repulsion configuration can, in at least some cases, be high or very high (e.g., approaching 100% efficiency). This is due in part to lower windage and bearing losses. However, in some embodiments, compared to a magnetic attraction configuration, a magnetic repulsion configuration can require more challenging assembly procedures and/or high magnet volume requirements for a given force and power transfer capability.

As seen in the exemplary embodiment of FIG. 24, the inner magnets 2404, 2406 (i.e., the magnets of the screw 1520) are generally magnetized outwardly, for example, while the outer magnets 2408, 2410 (i.e., the magnets of the nut 1510) are generally magnetized inwardly, for example. The direction of magnetization is generally radial with the preference of attraction or repulsion being determined by the particular design needs.

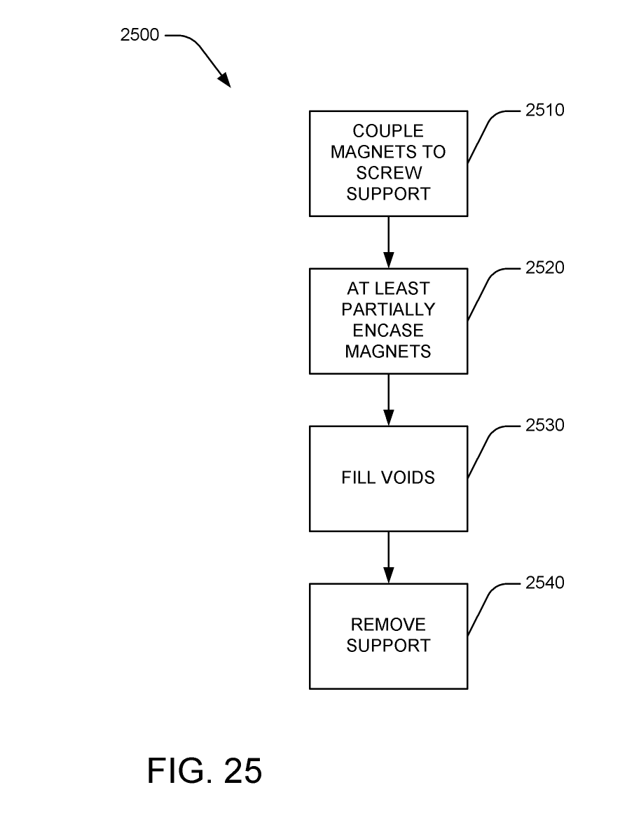

FIG. 25 shows a block diagram of an exemplary embodiment of a method 2500 for assembling at least a portion of a screw (e.g., the screw 1520). In a method act 2510, one or more magnets can be coupled to one or more supports, for example, the tube or rod 1630 and/or the outer tube 1640. This can include, for example, fastening the one or more magnets in place using one or more fastening approaches (e.g., pins, screws, adhesives, tongue-and-groove, and/or other approaches). In embodiments where pins are used, although not required, pins can be oriented relative to the center tube or rod 1630 (e.g., radially outward). This relative positioning of the pins and the center tube or rod can provide advantages of locking the magnet into position both in the radial and theta directions. In some cases it can be more practical to attach one magnet or a few magnets at a time to a selected area or areas of the center tube or rod 1630 and/or the outer tube 1640. This can avoid the potential problem of a magnet being difficult to attach due to repulsive forces between multiple magnets. Several individual magnets can be sized to collectively comprise more than a certain number of degrees of the helix (e.g., 180 degrees, 240 degrees, or other numbers of degrees). In at least some embodiments, this configuration can allow for radial fixation of the magnets when assembled onto a tube.

In a method act 2520, the magnets can be at least partially encased. For example, the outer tube 1640 can encase the magnets. In at least some embodiments, one or more voids can be provided between one or more magnets, the tube or rod 1630 and/or the outer tube 1640. In a method act 2530, the one or more voids can be filled with one or more non-magnetic materials (for example, lightweight epoxy or resin, which can comprise reinforcing fibers). In a method act 2540, the tube or rod 1630 and/or the outer tube 1640 can be removed.

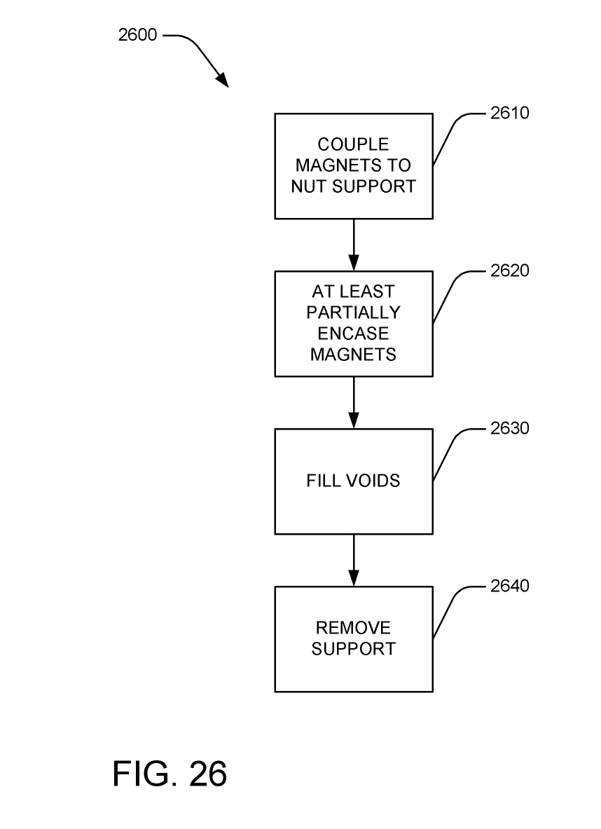

FIG. 26 shows a block diagram of an exemplary embodiment of a method 2600 for assembling at least a portion of the nut 1510. In a method act 2610, one or more magnets can be coupled to one or more supports, for example, the inner tube 1650 and/or the outer tube 1660. The one or more magnets can be fastened in place using one or more fastening approaches (e.g., pins, screws, adhesives, tongue-and-groove, and/or other approaches). In embodiments where pins are used, although not required, pins can be oriented relative to the inner tube 1650 (e.g., radially outward). This relative positioning of the pins and the center tube can provide advantages of locking the magnet into position in both the radial and theta directions. In some cases it can be more practical to attach one magnets or a few magnets at a time to a selected area or areas of the inner tube 1650. This can avoid the potential problem of a magnet being difficult to attach due to repulsive forces between multiple magnets.

In a method act 2620, the magnets can be at least partially encased. For example, the outer tube 1660 can encase the magnets. In at least some embodiments, one or more voids can be provided between one or more magnets, the inner tube and/or the outer tube. In a method act 2630, one or more voids can be filled with one or more non-magnetic materials (for example, lightweight epoxy or resin, which can comprise reinforcing fibers). In a method act 2640, the inner tube 1650 and/or the outer tube 1660 can be removed.

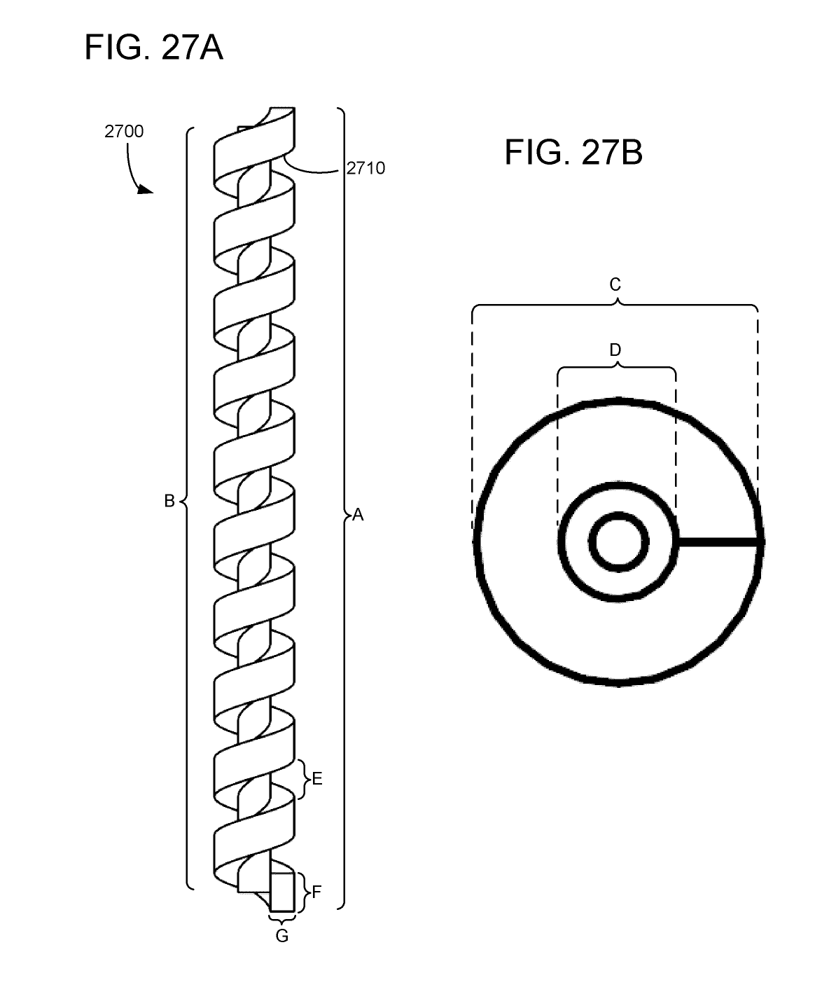

FIG. 27A shows a front view of an exemplary embodiment of a magnet support comprising a screw scaffold 2700. In the depicted embodiment, magnets can be inserted into one or more helical cavities 2710. Although the helical cavity 2710 of FIG. 27 is depicted as being continuous, further embodiments can comprise two or more separate helical cavities for receiving magnets. FIG. 27B shows a top view of the screw scaffold 2700. In some embodiments the screw scaffold 2700 comprises an inner cavity that extends at least a portion of the length of the scaffold 2700. The thread pitch of the helical cavities 2710 can vary, but in an exemplary embodiment the pitch is approximately 16.0 mm.

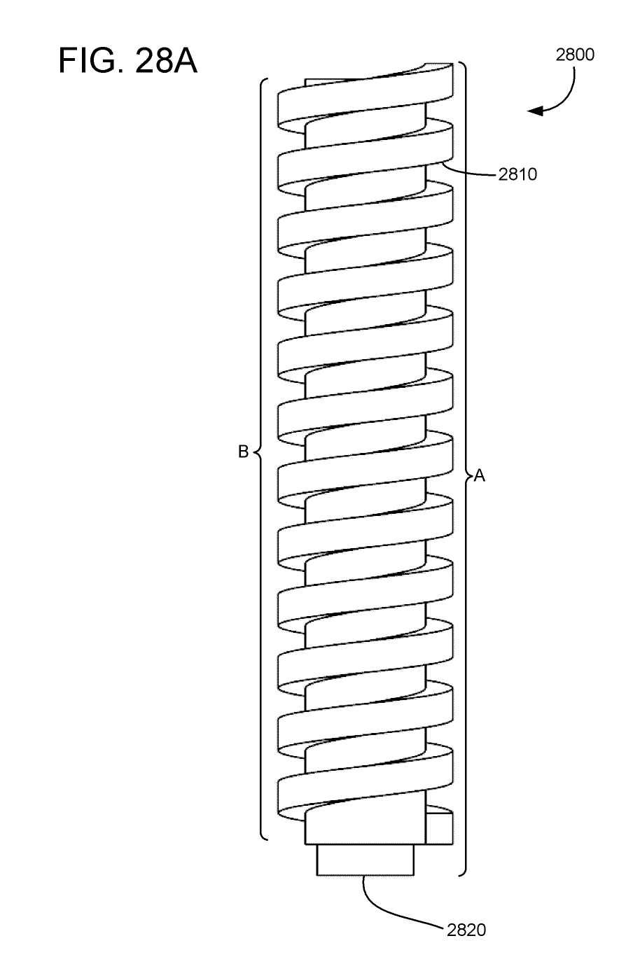

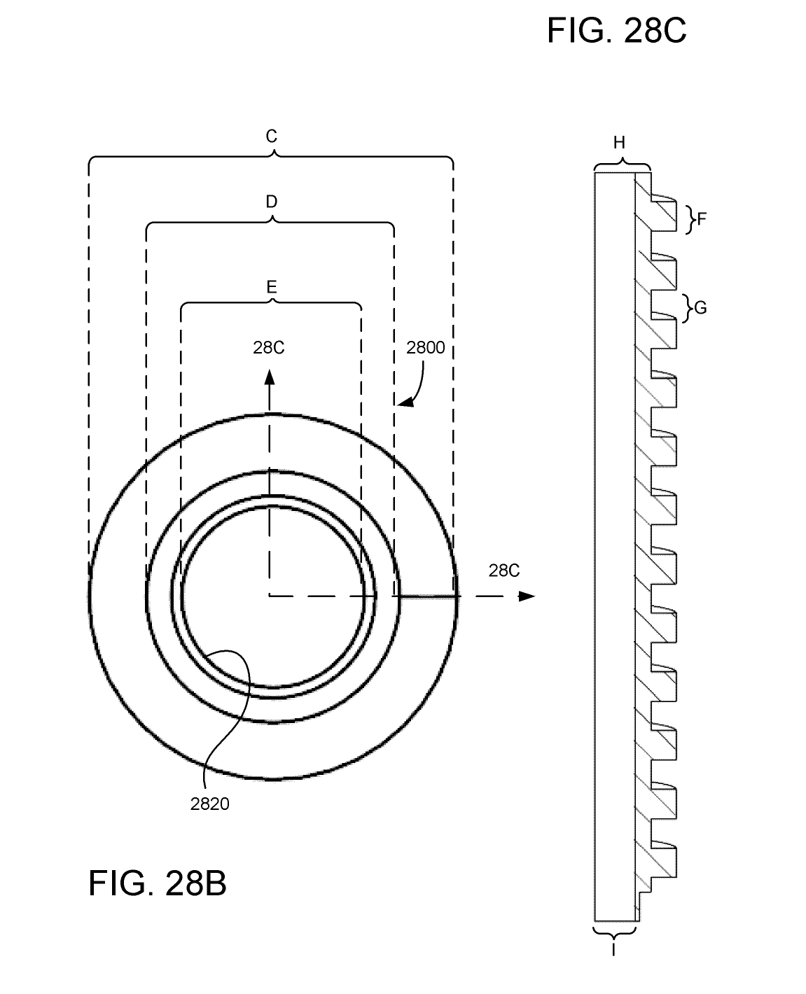

FIG. 28A shows a front view of an exemplary embodiment of a magnet support comprising a nut scaffold 2800. In the depicted embodiment, magnets can be inserted into one or more helical cavities 2810. The helical cavities 2810 can be continuous or separate. The depicted embodiment comprises a cylindrical body with a cavity 2820 for receiving a screw. In at least some embodiments, the cavity 2820 extends the length of the scaffold 2800, while in other embodiments it extends only a portion of the length of the scaffold 2800. The thread pitch of the helical cavities 2810 can vary, but in an exemplary embodiment the pitch is approximately 16.0 mm.

Generally, a screw scaffold 2700 and a corresponding nut scaffold 2800 have about the same or the same thread pitch. Magnets mounted in the helical cavities can have a height that is a percentage of the thread pitch (e.g., 20%, 30%, 50%, 60%, 80%, or another percentage). In some embodiments, the magnets mounted in the screw scaffold and the magnets mounted in the nut scaffold have approximately the same height; in other embodiments, the magnets have different heights.

Although the embodiments of FIGS. 27 and 28 show respective helical cavities 2710, 2810 as being on the outer surfaces of their respective scaffolds 2700, 2800, further embodiments can feature cavities for receiving magnets on interior surfaces of the scaffolds 2700, 2800, or on both interior and exterior surfaces.

Exemplary measurements for dimensions indicated in FIGS. 27A-B and 28A-C appear below in Tables 10 and 11, respectively. Further embodiments can use other dimensions.

TABLE 10
Dimensions for Scaffold 2700

| Dimension | Length (in) |
|---|---|
| A | 168 |
| B | 160 |
| C | 16.8 |
| D | 6.8 |
| E | 8 |
| F | 8 |
| G | 5 |

TABLE 11
Dimensions for Scaffold 2800

| Dimension | Length (in) |
|---|---|
| A | 208 |
| B | 196 |
| C | 44.8 |
| D | 30.8 |
| E | 22.23 |
| F | 8 |
| G | 8 |
| H | 15.4 |
| I | 11.11 |

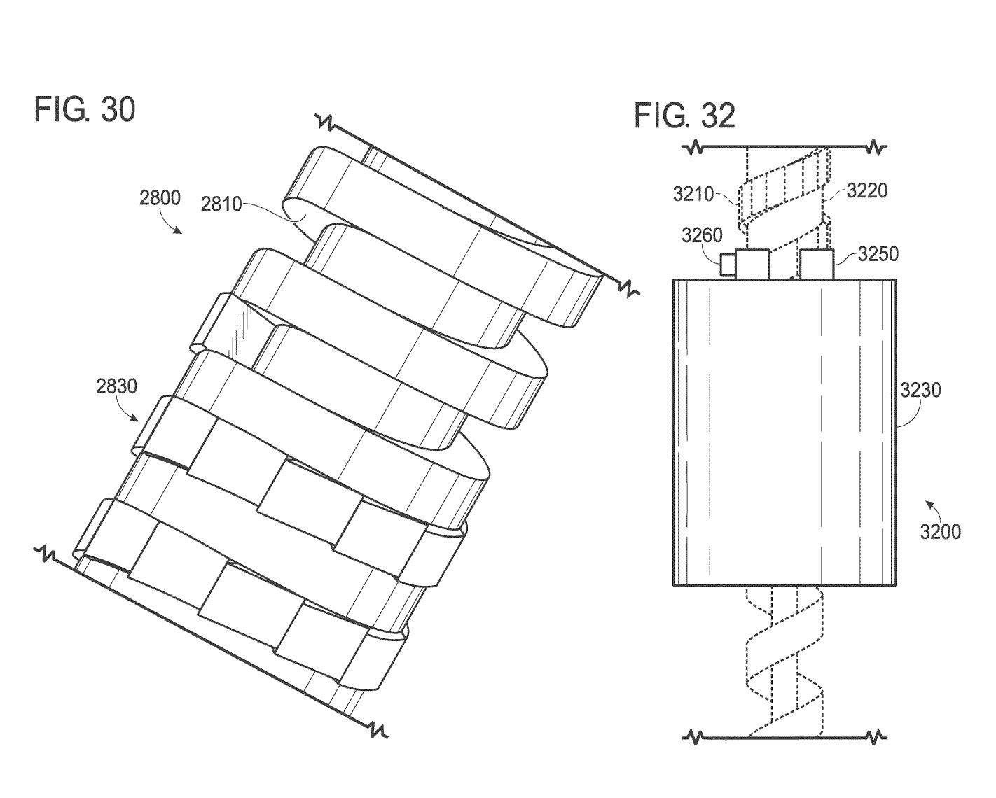

FIG. 29 shows a perspective view of a portion of the screw scaffold 2700 with a plurality of magnets 2720 in the helical cavity 2710. FIG. 30 shows a perspective view of a portion of the nut scaffold 2800 with a plurality of magnets 2830 in the helical cavity 2810.

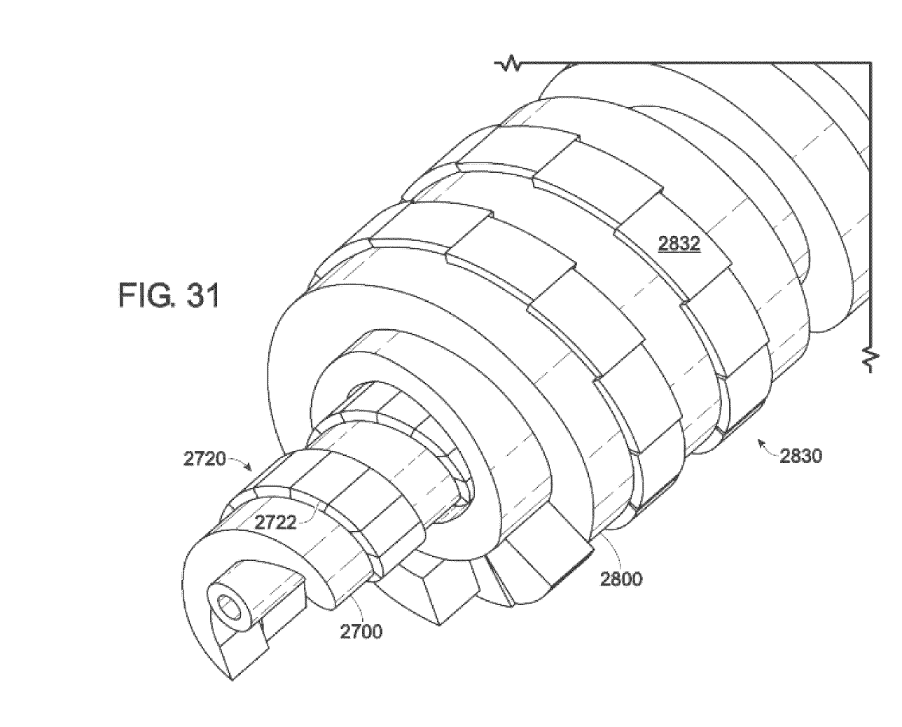

FIG. 31 shows portions of a perspective view of the screw scaffold 2700 inserted into the cavity 2820 of the nut scaffold 2800. As shown in FIG. 31, the magnets 2720 and the magnets 2830 are similar in shape to the magnets 2000 and 2100, respectively (see FIGS. 20 and 21). In the depicted embodiments, both of the magnets 2000 and 2100 are shaped such that when a plurality of either type of magnet is placed in a helical cavity on a screw scaffold or a nut scaffold, the magnets form a generally smooth face in the direction in which the magnets are magnetized, and a generally discontinuous face in the direction opposing (including, in some embodiments, substantially or partially opposing) that in which the magnets are magnetized. For example, in the embodiment of FIG. 31 the magnets 2720 of the screw (which are magnetized radially outward) form a generally smooth, outward-facing surface (as exemplified by “smooth” edge 2722), as well as a generally discontinuous, inward-facing surface (not shown). The magnets 2830 of the nut (which are magnetized radially inward) form a generally discontinuous, outward-facing surface (as exemplified by “jagged” edge 2832), and a generally smooth, inward-facing surface (not shown). Configuring the magnets 2830 of the nut and the magnets 2720 to have at least one generally smooth surface can reduce the air gap and potentially improve performance. In some cases, a discontinuous surface can contribute to cogging effects and can contribute to eddy current losses. In comparison, a less discontinuous surface can generally result in lower cogging effects and lower eddy losses. In at least some embodiments, magnets which are shaped such that they produce at least one generally discontinuous surface can be easier to manufacture than magnets shaped to produce two generally smooth surfaces. Some embodiments of the disclosed technologies can use magnets shaped so that pluralities of those magnets, when placed in a helical cavity, form two generally smooth surfaces, while in other embodiments the magnets form two generally discontinuous surfaces.

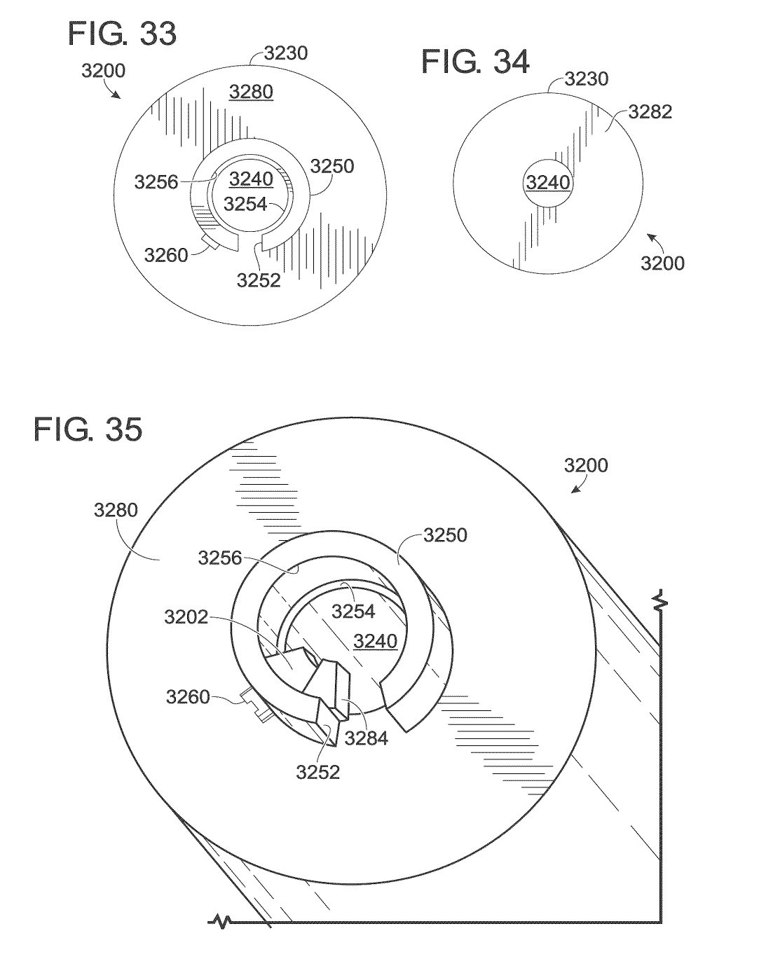

FIG. 32 shows a front view of an exemplary embodiment of a tool 3200 for assembling magnets 3210 onto a scaffold 3220. The scaffold 3220 features a helical cavity 3212 for receiving magnets. The tool 3200 comprises a body 3230 with a cavity 3240 (not shown in this view) and a restraint or collar 3250. In embodiments depicted herein, the body 3230 has a generally circular horizontal cross-section, but further embodiments can comprise a body with other horizontal cross-sections (e.g., ovate, polygonal). FIG. 33 shows a plan view of the tool 3200, which shows a top surface 3280 and the cavity 3240. In at least some embodiments, the cavity 3240 extends the length of the body 3230. In the depicted embodiment, the collar 3250 has a general C-shape, although the collar 3250 can take other shapes in further embodiments. The collar 3250 comprises an opening 3252, and the size of the opening 3252 relative to the collar 3250 can vary from embodiment to embodiment. Generally, the opening 3252 should be large enough to receive a magnet for attachment to a scaffold. In various embodiments, the collar 3250 can be fixed to the body 3230, or it can rotate relative to the body 3230. In the depicted embodiment, the collar 3250 has an interior diameter that is greater than the diameter of the cavity 3240, such that a ledge 3254 is formed between the rim of the cavity 3240 and an inner surface 3256 of the collar 3250. In some embodiments the ledge 3254 extends along all or substantially all of the inner surface 3256; in other embodiments, the ledge 3254 extends along only a portion of the inner surface 3256. FIG. 34 shows a bottom view of the tool 3200, which further comprises a bottom surface 3282. The tool 3200 can be used for assembling a nut component or a screw component, with the tool 3200 being sized to receive the corresponding scaffold.

FIG. 35 shows a perspective view of a portion of the tool 3200. In this figure, a die 3282 (referred to as a “magnet retainer” in some embodiments) is coupled to the inner surface 3256 of the collar 3250 using a fastener 3260. The depicted embodiment of the die 3282 is wedge-shaped, but further embodiments of the die 3282 can take on other shapes. At least a portion of the die 3282 comprises one or more magnetic materials (e.g., iron or other ferrous material). The die 3282 is configured such that a magnet 3284 is attracted to the die 3282 after the magnet 3284 is inserted through the collar opening 3252, thus holding the magnet in place for fastening. In various embodiments, the die 3282 can be positioned such that it is near the opening 3252 (e.g., adjacent to or offset from the opening 3252), while in further embodiments the die 3282 can be positioned such that it is elsewhere on the inner surface 3256 of the collar 3250.

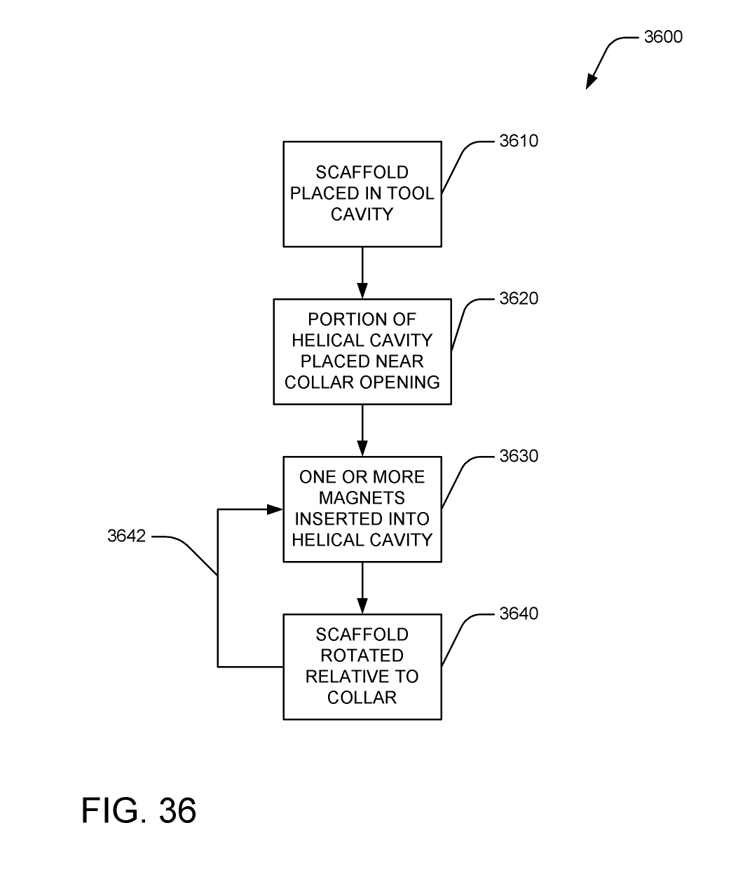

FIG. 36 shows a block diagram of an exemplary method 3600 for using a tool (e.g., the tool 3200 or a similar tool) to assemble magnets onto a scaffold, such as the screw scaffold 2700. (The method 3600 is described below as being applied to the screw scaffold 2700, but the method can also be applicable to a nut scaffold, such as nut scaffold 2800.) In at least some embodiments, the method 3600 can be used in combination with one or more method acts of the method 2500. In a method act 3610, the scaffold is placed in the tool cavity 3240. In a method act 3620, a portion of the helical cavity 2710 is positioned near the collar opening 3252. In a method act 3630, one or more magnets can be inserted into the helical cavity 2710 through the collar opening 3252. The one or more magnets can be coupled to the scaffold 2700. In some embodiments, the die 3282 can aid in holding the one or more magnets in place while they are coupled to the scaffold (e.g., with a relatively light magnetic attraction between the die 3282 and the one or more magnets). In a method act 3640, the scaffold 2700 can be rotated (or otherwise incrementally advanced) relative to the collar 3250 and raised relative to the tool top surface 3280. This can pull one or more magnets away from the die 3282 and can expose an additional portion of the helical cavity 2710 to the collar opening 3252. As indicated by the arrow 3642, method acts 3630, 3640 can be repeated until, for example, a selected portion of the helical cavity 2710 is occupied by magnets (e.g., until all or most of the cavity 2710 is occupied by magnets).

### Exemplary Embodiments of Component Alignment Technologies

In at least some embodiment of technologies described herein, components can be included to aid in maintaining alignment between screw and nut components. For example, components can help provide support for a screw in at least a radial direction. Generally, the screw 1520 can be supported at one or both ends to minimize shaft whip (e.g., when the nut and/or screw are moving at relatively high speeds). For example, returning briefly to FIG. 15, as the nut 1510 moves along at least a portion of the length of the screw 1520, the screw 1520 rotates on its radial axis. When the screw 1520 reaches a sufficient angular speed (what angular speed is “sufficient” can depend, for example, on the dimensions, materials and/construction of the screw 1520), the screw 1520 can begin to wobble and move in a radial direction relative to the nut 1510.

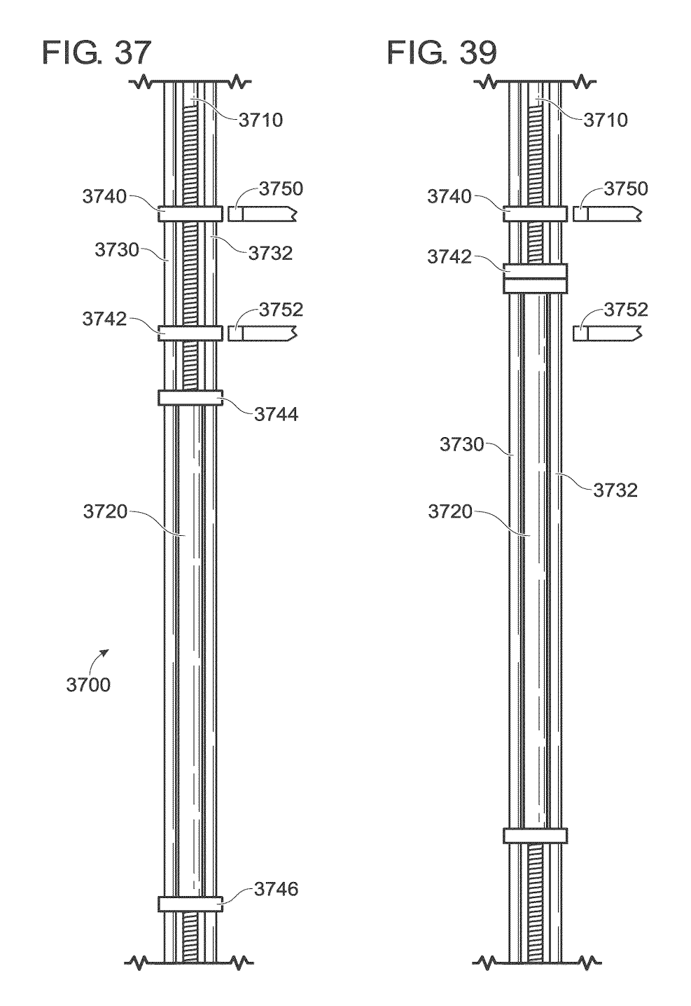

FIG. 37 shows an exemplary embodiment of a system 3700 for maintaining alignment between screw and nut components. In the depicted embodiment, a screw 3710 and a nut 3720 are similar, respectively, to the screw 1510 and the nut 1520 of FIG. 15. However, the system 3700 can be used with other embodiments of screws and nuts, including other embodiments disclosed herein.

The depicted embodiment of the system 3700 comprises one or more guide rods, such as guide rods 3730, 3732, which run generally parallel to the screw 3710. One or more portions of the guide rods 3730, 3732 can be affixed to a support structure (not shown). One or more guide blocks 3740, 3742, 3744, 3746 can be coupled to at least one of the guide rods 3730, 3732. In the depicted embodiment, the guide blocks 3740, 3742 are referred to as “floating” guide blocks, as their position relative to the nut 3720 can change, while the guide blocks 3744, 3746 are referred to as “fixed” guide blocks, since their position relative to the nut 3720 is generally unchanged. FIG. 37 shows floating guide blocks on one end of the system 3700 but not the other (i.e., above the nut 3720, but not below). In further embodiments, floating guide blocks can be positioned above and/or below the nut 3720. The floating guide blocks 3740, 3742 can be moveably held in place by support structures, such as 3750, 3752, respectively. The support structures 3750, 3752 can comprise, for example, magnets and/or a ball and detent configured to keep the floating guide blocks 3740, 3742 generally stationary until acted on by other forces. The number and placement of floating guide blocks for a given system can be determined based on one or more factors. For example, floating guide blocks can be chosen and positioned based on screw speed and/or one or more stability requirements.

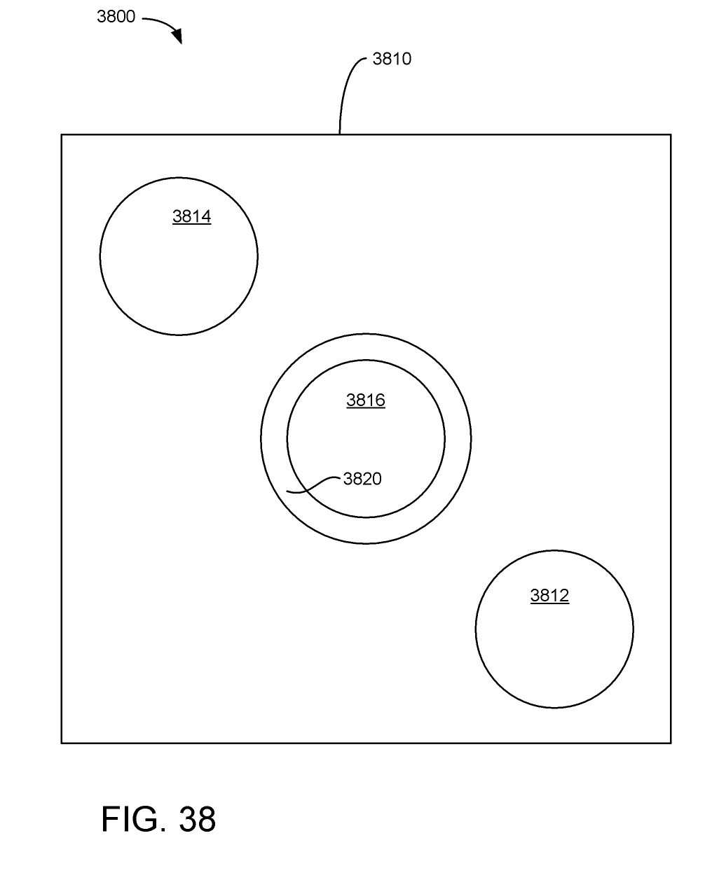

FIG. 38 shows a plan view of an exemplary embodiment of a guide block 3800. The block 3800 comprises a tile 3810 of one or more materials (e.g., metal, wood, ceramic, polymers and/or composites). The tile 3810 includes one or more apertures 3812, 3814 for receiving one or more guide rods (e.g., guide rods 3730, 3732). The tile 3810 is depicted as having a square perimeter, but further embodiments can have a number of other shapes. An aperture 3816 can be configured to receive a screw, such as the screw 3710. Some embodiments of the block 3800 comprise, adjacent to the aperture 3816, a friction-reducing component 3820 that can be positioned near the screw 3710. The friction-reducing component 3820 can comprise, for example, one or more of a ball-bearing system, a low-friction bushing system, and a magnet arrangement. In some embodiments the friction-reducing component 3820 can comprise a ring-shaped magnet (or a portion thereof) that is magnetized in a radial direction such that a repulsive force acts to center the screw shaft in the aperture 3816. Generally, the guide block 3800 and the guide rods 3730, 3732 can provide a restoring force to a screw that is moving out of alignment.

Returning to FIG. 37, as the nut 3720 moves upward, it (or the fixed guide block 3744) can contact the floating guide block 3742. As shown in FIG. 39, the guide block 3742 can be pushed away from the support structure 3752 and along the guide rods 3730, 3732. In at least some embodiments, the nut 3720 can continue to move upwards along the screw 3710 and displace the floating guide block 3740, moving it away from the support structure 3750. In further embodiments, where generally the nut 3720 spins and generally the screw 3710 is stationary, embodiments of the technologies described with respect to FIGS. 37-39 can be adapted to maintain alignment of the nut 3720.

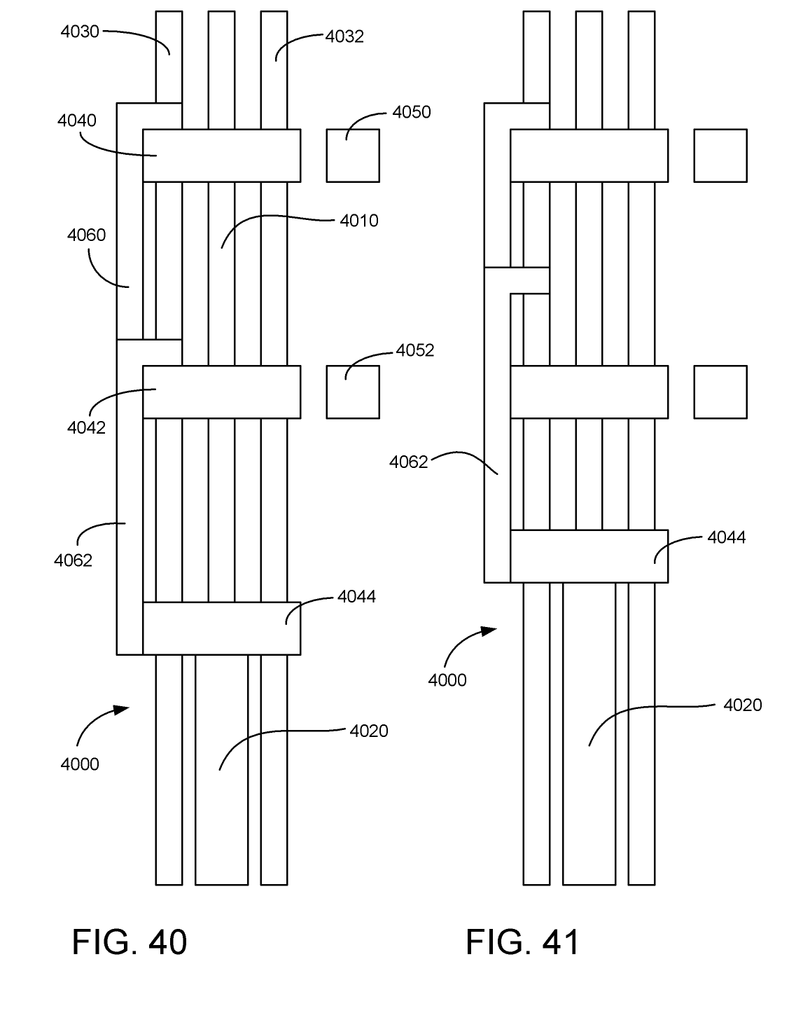

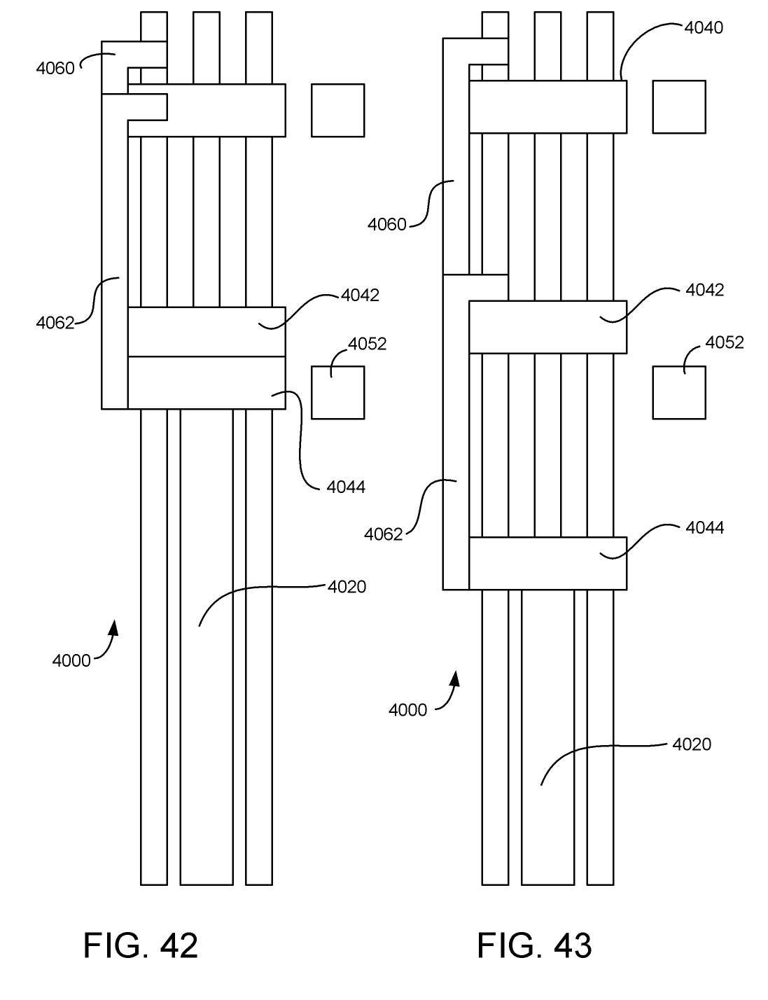

FIG. 40 shows details of an exemplary embodiment of a system 4000 for maintaining alignment between screw and nut components. The system 4000 shares some features of the system 3700; for example, the system 4000 comprises a screw 4010, a nut 4020, guide rods 4030, 4032, floating guide blocks 4040, 4042 with respective support structures 4050, 4052, and fixed guide block 4044. The system 4000 can also comprise realignment components, which in the depicted embodiment comprise brackets 4060, 4062 coupled to guides 4042 and 4044, respectively. Generally, the brackets 4060, 4062 can aid in replacing the floating guide blocks 4040, 4042 to their respective positions near the support structures 4050, 4052, after the blocks have been displaced by the upward motion of the nut 4020. FIG. 41 shows the system 4000 with the nut 4042, the fixed guide block 4044 and the bracket 4062 moved upward. In FIG. 42, the nut 4020 and the fixed guide block 4044 have displaced the floating guide block 4042, causing the bracket 4060 to be displaced, too. In FIG. 43, the nut 4020 and the fixed guide block 4044 have moved downward, causing the bracket 4062 to engage the guide block 4042. As the nut 4020 and the fixed guide block 4044 continue to move downward, the bracket 4062 will move the guide block 4042 back into its original position. Similarly, when the floating guide block 4040 is displaced, the bracket 4060 can engage the block 4040 and return it to its original position. Although the embodiment of FIGS. 40-43 depict the brackets 4060, 4062 as comprising rigid or semi-rigid, L-shaped structures, in further embodiments the realignment components can comprise flexible structures such as, for example, cords or chains.

Additionally, in at least some embodiments, repulsive magnetic forces between the nut at the screw can aid in maintaining alignment of portions of the screw in and near the nut.

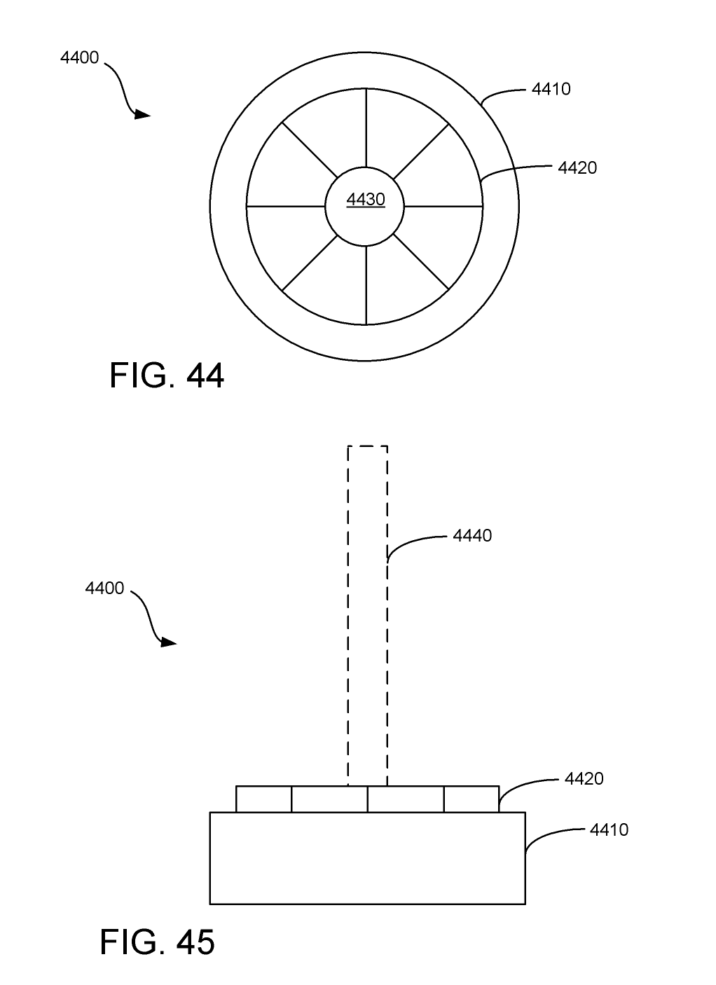

FIG. 44 shows a plan view of an exemplary embodiment of a radial bearing 4400 that can aid in maintaining alignment of a screw (e.g., the screw 4010 of FIG. 40). A base 4410 supports one or more magnets 4420, which surround an opening 4430 for receiving the end of a screw 4440. The one or more magnets 4420 are magnetized such that they exert a repulsive, inward force on the screw 4430, potentially aiding in maintaining alignment of the screw 4430. Although FIGS. 44 and 45 depict the base 4410, the plurality of magnets 4420 and the opening 4430 as being circular, these components can take additional shapes, too.

### Exemplary Output Torque and Repulsive Force Calculations

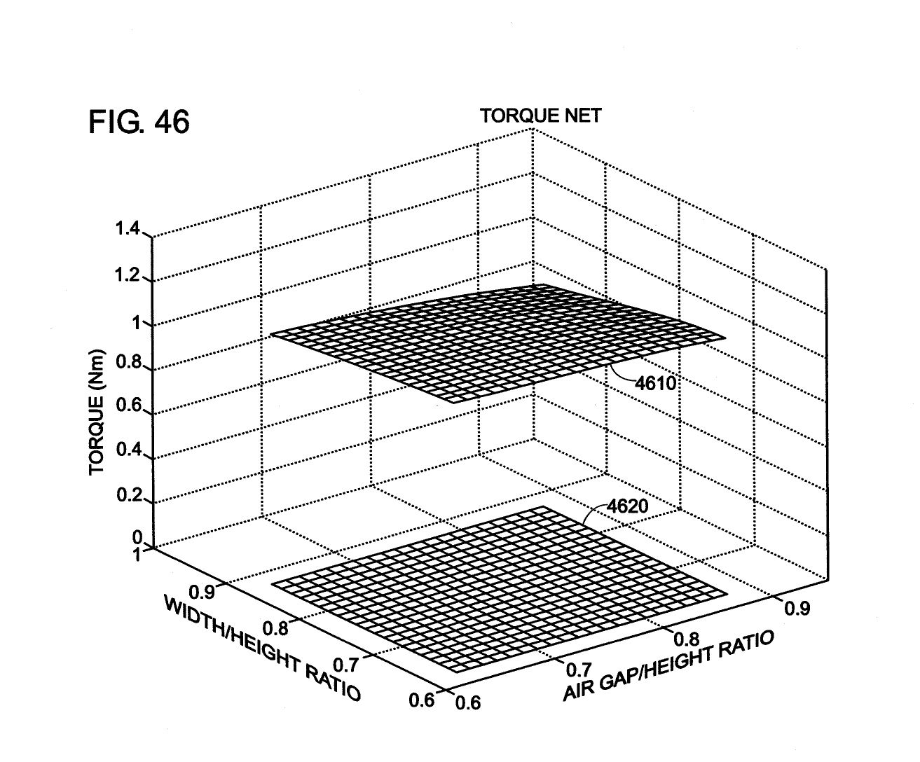

In at least some embodiments described herein, net maximum output torque of a magnetic helical screw drive (such as the system of FIG. 15, for example) is characterized as a function of the aspect ratio between magnet height (e.g., in the axial direction) to magnet width (e.g., in the radial direction) and the ratio between magnet height and the air gap (i.e., the air gap between the screw and nut). For example, one embodiment uses magnets having a width of about 6 mm, a height of about 8 mm (for a ratio of about 0.75) and an air gap of about 6 mm. FIG. 46 is a graph of exemplary torque estimates based on analytical calculations. Screw inertia due to acceleration is subtracted from the maximum torque in order to estimate the maximum net output torque, as represented by the upper plane 4610. The lower plane 4620 is the zero plane.

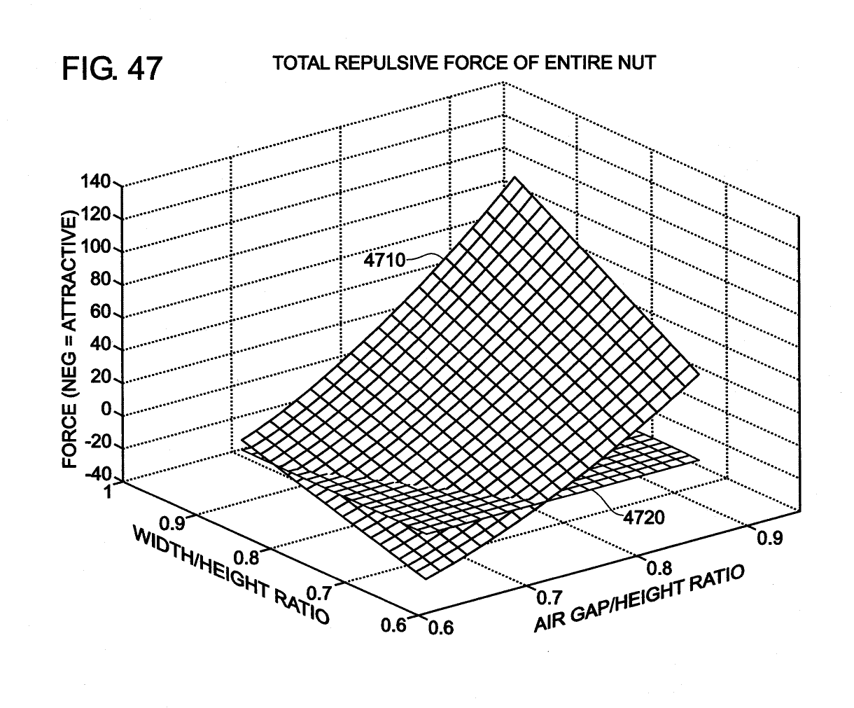

The repulsive force of the magnetic helical screw drive can also be characterized as a function of the aspect ratio between magnet height to magnet width and the ratio between magnet height and air gap (between the screw and nut), as similarly described above, and as shown by the plane 4710 in FIG. 47. The repulsive or attractive force estimates are based on analytical calculations. A transition between repulsion and attraction is seen at the crossing of the zero plane 4720. In some embodiments, a proper ratio between magnet height and air gap can be selected to place the system in repulsion design or attraction design. Too large of an air gap, while improving the repulsion for a given desired force, can sometimes cause an increase in magnet volume and cost and can be minimized.

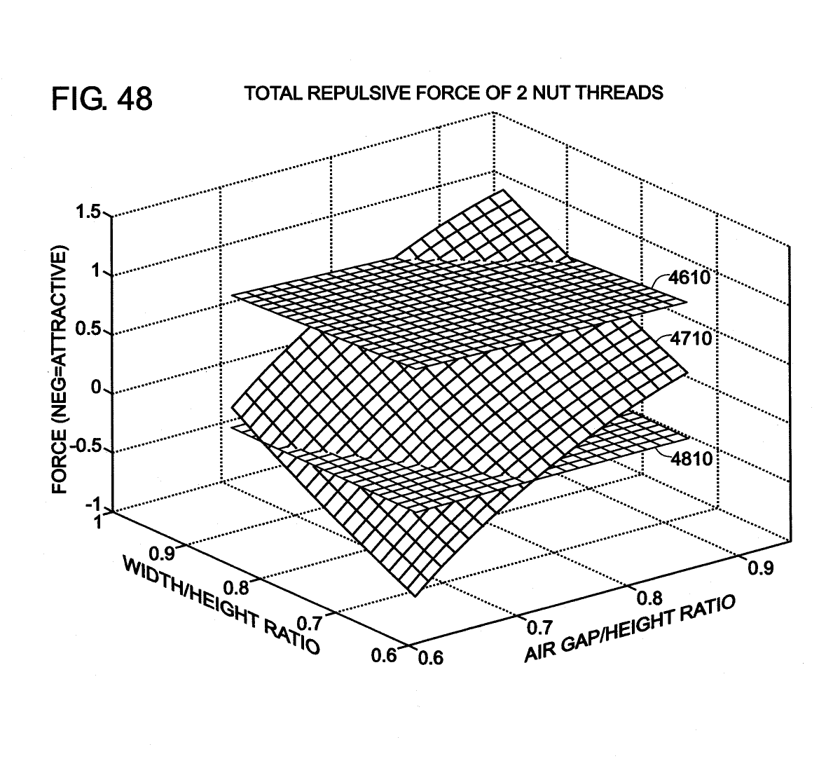

FIG. 48 shows the planes 4610, 4710 together with a zero plane 4810.

In view of the many possible embodiments to which the disclosed principles can be applied, it should be recognized that the illustrated embodiments are only examples and should not be taken as limiting in scope. Rather, the scope of the invention is defined by the following claims.

We claim:

1. An apparatus comprising:
a first magnet support;
a first plurality of magnets coupled to the first magnet support in a first helix arrangement;
a second magnet support having a cavity extending through at least a portion of the second magnet support, the cavity being configured to receive at least a portion of the first magnet support with one or more of the first plurality of magnets; and
a second plurality of magnets coupled to the second magnet support in a second helix arrangement at least partially about the cavity, and wherein the first plurality of magnets is configured to exert a repulsive force on the second plurality of magnets when the at least a portion of the first magnet support with one or more of the first plurality of magnets coupled thereto moves in the cavity relative to the second magnet support.

2. The apparatus of claim 1, wherein the first magnet support comprises a first longitudinal axis and wherein the first plurality of magnets is magnetized radially outward relative to the first longitudinal axis, wherein the second magnet support comprises a second longitudinal axis, and wherein the second plurality of magnets is magnetized radially inward relative to the second longitudinal axis.

3. The apparatus of claim 1, wherein the first magnet support comprises one or more helical cavities configured to receive one or more of the first plurality of magnets.

4. The apparatus of claim 1, wherein the second magnet support comprises one or more helical cavities configured to receive one or more of the second plurality of magnets.

5. The apparatus of claim 1, wherein at least some of the first plurality of magnets have an angular width of about 30 degrees.

6. The apparatus of claim 1, further comprising a void between a first magnet and a second magnet in the first plurality of magnets, wherein the void is at least partially filled with one or more non-magnetic materials.

7. The apparatus of claim 1, wherein the first plurality of magnets form a generally smooth first helical face and a generally discontinuous second helical face, wherein the first helical face opposes the second helical face.

8. The apparatus of claim 1, further comprising one or more alignment components coupled to the first magnet support.

9. The apparatus of claim 8, wherein the one or more alignment components coupled to the first magnet support comprise at least one guide block coupled to the first magnet support so as to be moveable relative to the first magnet support.

10. The apparatus of claim 9, wherein the one or more alignment components further comprise means for positioning the at least one guide block as a result of motion of the second magnet support.

11. The apparatus of claim 9, wherein the one or more alignment components further comprise a realignment component configured to position the at least one guide block as a result of motion of the second magnet support.

12. The apparatus of claim 11, wherein the one or more alignment components further comprise:
one or more rods coupled to the at least one guide block;
a first radial bearing configured to exert a first centering force on a first end of the first magnet support; and
a second radial bearing configured to exert a second centering force on a second end of the first magnet support.

13. A linear actuator comprising the apparatus of claim 1.

14. An ocean wave energy converter system comprising the apparatus of claim 1.

15. A method of converting between linear motion and rotary motion using the apparatus of claim 1, wherein the method comprises engendering relative motion between the first magnet support and the second magnet support when the at least a portion of the first magnet support with one or more of the first plurality of magnets coupled thereto is in the cavity of the second magnet support.

16. A method comprising:
placing a portion of a magnet support adjacent to a magnet assembly tool, the tool comprising a magnet retainer of one or more magnetic materials;
placing a magnet segment adjacent to the magnet support and the magnet retainer, such that the magnet segment is magnetically coupled to the magnet retainer;
attaching the magnet segment to the magnet support; and
incrementally advancing the magnet support relative to the magnet assembly tool so as to distance the magnet segment further from the magnet retainer.

17. The method of claim 16, wherein the magnet support comprises one or more helical cavities for receiving the magnet segment.

18. The method of claim 16, further comprising encasing the magnet segment and at least a portion of the magnet support.

19. The method of claim 16, wherein the magnet is a first magnet, the method further comprising, before incrementally advancing the magnet support relative to the magnet assembly:
placing a second magnet segment adjacent to the magnet support and the magnet retainer; and
attaching the second magnet segment to the magnet support.

20. The method of claim 19, the method further comprising filling a void between the first magnet segment and the second magnet segment with one or more non-magnetic materials.

21. An apparatus made according to the method of claim 16.

22. An apparatus comprising:
a magnet support comprising a longitudinal axis and a surface; and
a plurality of magnet segments coupled to the surface, wherein the plurality of magnets form at least a portion of a helix relative to the longitudinal axis, and wherein substantially all of the magnets coupled to the surface are magnetized in a common direction.

23. The apparatus of claim 22, further comprising one or more helical cavities adjacent to the surface of the magnet support, wherein the plurality of magnet segments are coupled to the one or more helical cavities.

24. The apparatus of claim 22, wherein the magnet support is a first magnet support, the longitudinal axis is a first longitudinal axis, the plurality of magnet segments is a first plurality of magnet segments, the common direction is a first common direction, and the surface is a first surface, the apparatus further comprising:
a second magnet support comprising a second longitudinal axis, a second surface and a cavity configured to receive at least a portion of the first plurality of magnet segments; and
a second plurality of magnet segments coupled to the second surface, wherein the second plurality of magnets form at least a portion of a second helix relative to the second central axis, wherein substantially all magnets on the second surface are magnetized in a second common direction, and wherein the second common direction is generally opposite to the first common direction.

25. An apparatus for assembling magnets on a magnet support, the apparatus comprising:
a body, the body comprising a body opening configured to receive the magnet support;
a restraint positioned adjacent to the body opening, the restraint comprising an inner surface, an outer surface, and a restraint opening configured to receive one or more magnets for coupling with the magnet support; and
a magnet retainer coupled to the inner surface of the restraint, wherein the magnet retainer comprises one or more magnetic materials.

26. The apparatus of claim 25, wherein the body opening has a first diameter and the inner surface of the restraint has a second diameter.

27. The apparatus of claim 25, wherein the magnet retainer comprises a wedge-shaped body.

28. The apparatus of claim 25, wherein the magnet retainer is offset from the restraint opening.
